(19) United States
(12) Patent Application Publication
(10) Pub. No.: US 2024/0362877 A1
(43) Pub. Date: Oct. 31, 2024

(54) METHOD AND APPARATUS FOR DETERMINING MORPHOLOGY OF A HUMAN BREAST AND/OR PROVIDING A MANUFACTURED GARMENT

(71) Applicant: Brarista Ltd, London (GB)

(72) Inventors: Prashant Aparajeya, London (GB); Vandita Shukla, London (GB); Salman Khan, London (GB); Frederic Leymarie, London (GB); Tigran Hakobyan, London (GB); Tang Thuy Trang Ngo, London (GB)

(21) Appl. No.: 18/577,675

(22) PCT Filed: Jul. 7, 2022
(86) PCT No.: PCT/GB2022/051755

§ 371 Date: Jan. 8, 2024

(30) Foreign Application Priority Data
Jul. 7, 2021 (GB) 2109828.0
Jul. 7, 2021 (GB) 2109831.4

(51) Int. Cl. G06T 19/20; G06T 7/60

(52) U.S. Cl. CPC G06T 19/20; G06T 7/60; G06T 2207/20036; G06T 2207/30196; G06T 2210/16; G06T 2219/2016; G06T 2219/2021

(57) ABSTRACT

A computer-implemented method and apparatus for determining morphology of a human breast, the method comprising: obtaining at least one image of a subject; extracting features of at least a portion of the subject's body from the at least one image, wherein the features correspond to a model of standard human anatomy; generating a three-dimensional model of the subject's body based on the extracted features and the model of standard human anatomy; and determining a morphological parameter of the subject's breast from the three-dimensional model of the subject's body. In another aspect, a computer implemented method is presented for adjusting a virtual garment to fit the three-dimensional model and determining a parameter based on the adjusted virtual garment. In a further aspect, there is provided a method for providing a manufactured wearable garment. In another aspect, there is provided a computer implemented method for determining a morphological parameter of a subject's body, the method comprising: obtaining a first two-dimensional image and a second two-dimensional image, showing a view of the subject and a reference object in a first and second position relative to the subject; determining size information of the subject based on an apparent size of the reference object in the first image and the second image; generating a three-dimensional model of the subject's body based on the size information; and determining a morphological parameter of the subject's body from the three-dimensional model of the subject's body.

### FIELD

The present invention relates to a computer-implemented method and apparatus for determining morphology of a human body, in particular a human breast, and also to a computer-implemented method and apparatus for determining morphology of a human body, in particular for the fitting of garments to the human body and for the provision of such garments whether by manufacture or otherwise.

### BACKGROUND

Automated measurement of the human body based on two dimensional (2D) images presents a difficult problem. Although there is a general standard anatomy to which the human body generally conforms, there is also considerable variability between individuals. From a technical and quantitative point of view, it may be challenging to establish a reproducible measurement of the human anatomy because, put simply, it is not always clear what is being measured. For example, the viewpoint from which an image is captured may have an impact on the apparent proportions of the subject's body, as may the subject's posture. Measurement of the morphology of the real human breast is still more problematic than measurement of the larger scale features of human anatomy.

For example, it might be relatively simple to identify the relative proportions of the limbs and the torso in a digital image, but assessment of the volume, shape, and/or position of the breast is much less straightforward. In technical fields such as the fitting and manufacture of garments and prosthetics, the ability accurately to perform such measurements would provide significant advantages.

More broadly, the ability to determine morphological parameters of the human body, (such as those indicating shape and/or size) has a range of possible applications including virtual tailoring and garment fitting, health and fitness, and gaming and entertainment (for example, generating avatars).

With specific reference to the breast, the ability to perform breast measurements “virtually” e.g. based on digital data would suit a range of applications including underwear and shapewear fitting, breast prosthesis fitting, and preparation for breast augmentation or surgery.

Published patent application CN106228417A discusses a brassiere “goodness-of-fit” detection method, where a three-dimensional (3D) scanning model of a brassiere is acquired and a human body model is deformed to align with the 3D scanned model of the brassiere. Corresponding model parameters are calculated for the deformed model which are then used to calculate “goodness-of-fit” of the bra.

Published patent U.S. Pat. No. 10,055,851 describes a method for determining body measurements, including breasts, from a digital image of a subject, wherein the image includes a reference object of known dimensions. Reference points are identified manually in the image using markers, the markers are used to identify regions of interest of the body. Contour information is then extracted from the regions of interest in the image. Contour information is also extracted from pre-stored 3D models corresponding to different sizes and shapes of human bodies. The contour information from the image is then compared to the contour information from the 3D models to identify the 3D model which best represents the subject's body. The best-match 3D model is then used to identify sizing information for the subject.

However, current virtual breast measurement and/or bra-fitting methods are limited in their ability to provide accurate breast measurements given the large variety of different breast shapes and sizes, for example wherein body determination is based on indirect or ‘best-match’ fitting techniques. More accurate body morphology determination and measurement techniques typically rely on expensive equipment and highly controlled measurement environments.

Consumer demand for higher quality and better fitting garments, such as clothing and prosthetics, is increasing all the time. In earlier times it was possible for customers to visit shops such as tailors and dressmakers and to have such articles created bespoke or at least made-to-measure. Present consumer preferences will not permit this—the demand for lower prices and the demand to have articles produced on demand, often with very short lead times, has rendered these prior approaches unacceptable. The advent of high quality digital cameras, and their integration into ubiquitous user equipment such as smartphones provides an opportunity in that consumers are able easily to create images of themselves or others to whom such articles are to be fitted, and to send these to a supplier of such articles.

However, the fitting of a garment to a human body requires detailed measurement. Such measurement is not easily performed using 2D images, even by highly trained personnel with accurate measuring tools and long years of experience. Automated measurement of the human body based on such two dimensional (2D) images also presents a difficult technical problem. Although there is a general standard anatomy to which the human body generally conforms, there is also considerable variability between individuals. From a technical and quantitative point of view, it may be challenging to establish a reproducible measurement of the human anatomy because, put simply, it is not always clear what is being measured. For example, the viewpoint from which an image is captured may have an impact on the apparent proportions of the subject's body, as may the subject's posture. Measurement of the morphology of the real human breast is still more problematic than measurement of the larger scale features of human anatomy.

For example, it might be relatively simple to identify the relative proportions of the limbs and the torso in a digital image, but assessment of the volume, shape, and/or position of the breast is much less straightforward. In technical fields such as the fitting and manufacture of garments and prosthetics, the ability accurately to perform such measurements would provide significant advantages.

More broadly, the ability to determine morphological parameters of the human body, (such as those indicating shape and/or size) has a range of possible applications including virtual tailoring and garment fitting, health and fitness, and gaming and entertainment (for example, generating avatars).

With specific reference to the breast, the ability to perform breast measurements “virtually” e.g. based on digital data would suit a range of applications including underwear and shapewear fitting, breast prosthesis fitting, and preparation for breast augmentation or surgery. This virtual measurement data may then be used to provide a suitable manufactured wearable garment for the human subject.

CN106228417A discusses a brassiere goodness-of-fit detection method wherein a three-dimensional (3D) scanning model of a brassiere is acquired, and a human body model is deformed to align with the 3D scanned model of the brassiere. Corresponding model parameters are calculated for the deformed model which are then used to calculate goodness of fit of the bra.

U.S. Pat. No. 10,055,851 describes a method for determining body measurements, including breasts, from a digital image of a subject, wherein the image includes a reference object of known dimensions. The subject identifies reference points in the image using markers, the markers are used to identify regions of interest of the body. Contour information is then extracted from the regions of interest in the image. Contour information is also extracted from pre-stored 3D models corresponding to different sizes and shapes of human bodies. The contour information from the image is then compared to the contour information from the 3D models to identify the 3D model which best represents the subject's body. The best-match 3D model is then used to identify sizing information for the subject.

The provision of improperly fitting garments is wasteful and undesirable. However, 10 consumers increasingly wish to purchase garments without visiting a retail facility to try them on. The lack of convenient and accurate measurement of body morphology makes this very challenging. It is particularly challenging for garments such as clothing and prosthetics which are to fit or to augment the breast. Current virtual breast measurement and/or bra-fitting methods are limited in their ability to provide accurate breast measurements given the large variety of different breast shapes and sizes, for example wherein body determination is based on indirect or ‘best-match’ fitting techniques. More accurate body morphology determination and measurement techniques typically rely on expensive equipment and highly controlled measurement environments. The problem of how to provide properly fitting garments without the wearer trying them on remains unsolved.

### SUMMARY OF INVENTION

Aspects and embodiments of the present disclosure are set out in the claims and aim to address at least some of the above-described technical problems, and other problems. Such aspects and examples may be provided in conjunction with each other and features of one aspect may be applied to other aspects.

In a first aspect there is provided a computer-implemented method of determining morphology of a human breast, wherein the method comprises obtaining at least one image of a subject and extracting features of at least a portion of the subject's body from the at least one image, wherein the features correspond to a model of standard human anatomy. The at least one image may comprise a plurality of images. The at least one image may be a two-dimensional, 2D, image, for example a plurality of 2D images. In some examples, the at least a portion of the subject's body comprises at least the torso.

The method then generates a three-dimensional model of the subject's body based on the extracted features and the model of standard human anatomy. A morphological parameter of the subject's breast is then determined from the three-dimensional model of the subject's body. The subject may be male or female. The subject may be an adult or an adolescent human, such as an adolescent male or female.

The morphological parameter may be a measurement, such as a measurement of size or shape or position of the breast. Example morphological parameters may include, but are not limited to, at least one of breast volume, breast shape (for example tear-drop, full-on-top, heavy-on bottom, dripping etc.), breast root topography, breast orientation, breast separation, presence of side breast, side breast volume, side breast area, breast tissue distribution, breast 3D control points, bandline length, bandline location, breast-garment association, garment size, breast root location, breast root height and/or width, breast tissue strength.

The model of standard human anatomy may comprise a model skeleton, for example it may comprise data indicating the location of selected landmarks of the skeleton, such as the location of the shoulder joints of the skeleton.

Generating the three-dimensional, 3D, model of the subject may further comprise deforming the model of standard human anatomy based on the extracted features. For example, the extracted features may correspond to the selected landmarks of the skeleton.

The method may comprise determining a transform based on (a) location data (e.g. coordinates) corresponding to the extracted features from the images of the subject; and (b) location data corresponding to the selected landmarks of the skeleton. The transform may comprise a non-rigid transform. The method may comprise determining this transform based on minimising an error function describing the difference between the location data corresponding to the extracted features and the location data corresponding to the selected landmarks. The error function may be based on Euclidean distances between the two sets of location data. A least squares method may be used for this purpose, such as a moving least squares method, MLS. The error function may comprise a deformation function to account for the non-rigid nature of the transform. The error function may be regularized.

The method may comprise applying the determined transform to the model of standard human anatomy to generate the 3D model of the subject. The 3D model of the standard human anatomy and/or the subject may be a mesh model.

The non-rigid transform may be selected to transform the model onto the subject, thereby to provide an estimate of the subject's body shape. This may be done by coinciding and/or aligning the extracted features of the subject's body with the features of the three-dimensional model. As noted above, the non-rigid transform may be determined using a moving regularized least square error minimisation algorithm; however, other deformation methods may be used.

The model of standard human anatomy, for example a model skeleton, typically comprises 3D digital data defining said landmarks. This may be stored in a computer readable memory. The stored model of standard human anatomy may be marked to identify at least one of (i) an anatomical marker; and (ii) an anatomical marker identifying an important skeletal region for determining a morphological parameter of the breast.

In some examples, the features identified in the image(s) of the subject comprise anatomical landmarks such as the umbilicus and at least one of the shoulder joints. Examples of such landmarks may include, but are not limited to, at least one of shoulder joints (for example head of the humerus), umbilicus, ribs pairwise, mid-points of each rib-pair, umbilicus, spinal vertebra end-points, spinal vertebra mid-points, pose registration axis, marking of spinal vertebras and/or disks index points passing through pose registration axis, spinal vertebra and/or disk index points orthogonal to the umbilicus, end-point of sternum, width and/or height of sternum, jugular notch. In some examples, the location of the umbilicus of the subject may be used to determine the location of the junction between the 3rd and 4th lumbar vertebrae due to the known anthropometric relationship of standard human anatomy between the umbilicus and the junction between the 3rd and 4th lumbar vertebrae.

The at least one image of the subject may comprise the subject in a pre-determined pose. In some examples, the predetermined pose comprises a neutral spine and abduction of the arms at the shoulder, for example with the upper arms extended laterally in the coronal plane. The predetermined pose may comprise the user standing, for example with a neutral spine and abduction of the arms at the shoulder, for example with the upper arms extended laterally in the coronal plane. The elbows may be flexed with the fingers touching each side of the subject's head, for example approximately around the ear.

In some examples, extracting features of at least a portion of the subject's body further comprises extracting edge information of at least a portion of the subject's body from the at least one image. In some examples, extracting features of at least a portion of the subject's body further comprises identifying and measuring points of inflection based on the edge information. In some examples, the points of inflection are used to identify anatomical regions of interest, for example breast root.

In some examples, generating the three-dimensional model of the subject further comprises scaling the three-dimensional model of the subject based on size information obtained from the at least one image. In some examples, the at least one image comprises a reference object, the method comprising determining size information based on an apparent size of the reference object in the at least one image, wherein the actual size of the reference object is known. In some examples, the reference object is positioned on the same plane as at least a portion of the subject's body in the image.

In some examples, determining a morphological parameter of the subject's breast from the three-dimensional model of the subject's body further comprises adjusting a virtual garment to fit the three-dimensional model, and determining at least one of (a) a morphological parameter of the breast based on the adjusted virtual garment, and (b) a parameter of a real garment based on the adjusted garment. In some examples, the virtual garment comprises a support element configured to support at least a portion of the subject's breast. In some examples, adjusting the virtual garment to fit the three-dimensional model comprises deforming a breast part of three-dimensional model of the subject to fit the support element, wherein the deforming is constrained to preserve volume of the breast part of the three-dimensional model.

In some examples, the virtual garment (a) comprises a virtual prosthesis or (b) consists solely of a virtual prosthesis. In some examples, the method comprises identifying a desired morphology of at least one of the subject's breasts and adjusting the virtual prosthesis so that, when the virtual prosthesis is positioned on the three-dimensional model to augment a virtual breast of the model, the augmented virtual breast has the desired morphology. In some examples, the desired morphology comprises a desired shape, and the adjusting the virtual prosthesis comprises deforming the virtual prosthesis while constraining a total volume of the virtual prosthesis. In some examples, the total volume of the virtual prosthesis may comprise the volume of the augmented breast and the prosthesis together.

In some examples, wherein the virtual garment (a) comprises a virtual prosthesis or (b) consists solely of a virtual prosthesis, the method comprises identifying a first morphological parameter of a first one of the subject's breasts, such as volume, wherein the virtual prosthesis corresponds to the second one of the subject's breasts, and deforming the virtual prosthesis under a constraint that the first morphological parameter of the virtual prosthesis matches the first morphological parameter of the first one of the subject's breasts. The method then identifies a second morphological parameter of the adjusted virtual prosthesis. In some examples, the morphological parameter of the virtual prosthesis, such as volume, may comprise the parameter of the second one of the subject's breasts and the prosthesis together.

In some examples, the method comprising determining at least one of (i) a garment size, and (ii) a manufacturing parameter, of at least one of a real prosthesis and a real garment based on the determined morphological parameters. In some examples, the method comprises providing a control signal adapted for controlling a garment provision apparatus to cause the provision of a wearable article, for the subject, based on the determined morphological parameters.

In an aspect there is provided an apparatus for determining morphology of a human breast, the apparatus comprising a processor configured to perform any one or more of the methods described or claimed herein. This apparatus may further comprise an image capture device for capturing a plurality of images of a subject.

In some examples, the apparatus is configured to send a determined morphological parameter, such as a parameter of the subject's breast to a remote device.

In some examples, the apparatus may not comprise an image capture device, for example it may be configured to receive the plurality of images from a remote device, e.g. via a communications network.

In some examples, the apparatus is provided by so-called user equipment (UE), for example a communications device comprising a camera and a communications interface, such as a tablet computer or mobile telecommunications handset.

The apparatus may further comprise a memory configured to store a model of standard human anatomy. In some examples, the memory is further configured to store at least one three-dimensional virtual garment mould.

In an aspect, there is provided a computer program product comprising program instructions configured to program a processor to perform any one or more of the methods described or claimed herein.

In an aspect there is provided a computer implemented method for determining a morphological parameter of a subject's body, the method comprising obtaining a first two-dimensional image showing a first view of the subject and a reference object in a first position relative to the subject, and obtaining a second two-dimensional image showing a view of the subject and a reference object in a second position relative to the subject, wherein the second position is different from the first position. Size information of the subject is then determined based on an apparent size of the reference object in the first image and the second image, and a three-dimensional model of the subject's body is generated based on the size information. A morphological parameter of the subject's body can then be determined from the three-dimensional model of the subject's body.

In some examples, the first view of the subject is different from the second view of the subject.

In some examples, the size information comprises size information corresponding to at least two different planes of a three-dimensional space. In some examples, generating the three-dimensional model comprises applying the size information from the at least two different planes to corresponding planes of the three-dimensional model.

In some examples, the first position of the reference object and the second position of the reference object each correspond to different positions of a predetermined set of anatomical locations. Example anatomical locations may include, but are not limited to, the sternum, on the highest point of one breast, the collar bone, the jugular notch, and ribcage.

In some examples, the predetermined set of anatomical locations each correspond to different planes in a standard three-dimensional model of the human body. In some examples, generating of the three-dimensional model comprises scaling the standard three-dimensional model in the different planes according to corresponding size information for those planes determined from the apparent size of the reference object.

In an aspect there is provided, an apparatus for providing a manufactured wearable garment for a human subject, the apparatus comprising an image data store for storing image data and a garment fit data store. The garment fit data store is configured to store a plurality of items of garment fit data, each item of garment fit data corresponding to at least one manufacturable garment. The apparatus further comprises a data processor, arranged to communicate with the garment fit data store and the image data store. The data processor is configured to obtain a digital image of the subject in a pre-determined pose from the image data store, wherein the predetermined pose comprises abduction of the arms at the shoulder. The data processor is then configured to determine, based on the digital image of the subject in the predetermined pose, at least one morphological parameter of the subject's body, for example at least one morphological parameter of the subject's breast. The data processor is then further configured to provide garment fit data based on the at least one morphological parameter, and to provide a control signal for controlling a garment provision system for the provision of a manufactured garment according to the garment fit data.

The predetermined pose may comprise a neutral spine, for example with the subject standing. The predetermined pose may also comprise abduction of the arms at the shoulder, for example with the upper arms extended laterally in the coronal plane. The predetermined pose may further comprise the arms being flexed with fingers touching the side of the head, for example approximately around the ear.

The apparatus may further comprise an image capture device operable to capture a first digital image of the subject. The processor may be configured to determine based on the digital image, whether the subject is in the predetermined pose, and to cause the capture of a further image of the subject in the event that the subject is not in the predetermined pose in the first digital image.

The digital image of the subject in a pre-determined pose may further comprise a reference object positioned in a pre-determined location relative to the subject's body, and wherein the data processor is further configured to determine size information of the subject based on an apparent size of the reference object in the digital image. In some examples, determining the at least one morphological parameter is based on the size information of the subject.

The morphological parameter of the subject's body may comprise at least one morphological parameter of the subject's breast. The apparatus is configured to determine the morphological parameter of the subject's breast by a method comprising extracting features of at least a portion of the subject's body from the digital image of the subject, wherein the features correspond to a model of standard human anatomy. The at least one image may comprise a plurality of images. The at least one image may be a two-dimensional, 2D, image, for example a plurality of 2D images. In some examples, the at least a portion of the subject's body comprises at least the torso.

A three-dimensional model of the subject's body is then generated based on the extracted features and the model of standard human anatomy. A morphological parameter of the subject's breast may then be determined from the three-dimensional model of the subject's body. The subject may be male or female. The subject may be an adult or adolescent human, such as an adolescent male or female.

The morphological parameter may be a measurement, such as a measurement of size or shape or position of the breast. Example morphological parameters may include, but are not limited to, at least one of breast volume, breast shape (for example tear-drop, full-on-top, heavy-on bottom, dripping etc.), breast root topography, breast orientation, breast separation, presence of side breast, side breast volume, side breast area, breast tissue distribution, breast 3D control points, bandline length, bandline location, breast-garment association, garment size, breast root location, breast root height and/or width, breast tissue strength.

The model of standard human anatomy may comprise a model skeleton, for example it may comprise data indicating the location of selected landmarks of the skeleton, such as the location of the shoulder joints of the skeleton.

Generating the three-dimensional, 3D, model of the subject may further comprise deforming the model of standard human anatomy based on the extracted features. For example, the extracted features may correspond to the selected landmarks of the skeleton.

The method may comprise determining a transform based on (a) location data (e.g. coordinates) corresponding to the extracted features from the images of the subject; and (b) location data corresponding to the selected landmarks of the skeleton. The transform may comprise a non-rigid transform. The method may comprise determining this transform based on minimising an error function describing the difference between the location data corresponding to the extracted features and the location data corresponding to the selected landmarks. The error function may be based on Euclidean distances between the two sets of location data. A least squares method may be used for this purpose, such as a moving least squares method, MLS. The error function may comprise a deformation function to account for the non-rigid nature of the transform. The error function may be regularized.

The method may comprise applying the determined transform to the model of standard human anatomy to generate the 3D model of the subject. The 3D model of the standard human anatomy and/or the subject may be a mesh model.

The non-rigid transform may be selected to transform the model onto the subject, thereby to provide an estimate of the subject's body shape. This may be done by coinciding and/or aligning the extracted features of the subject's body with the features of the three-dimensional model. As noted above, the non-rigid transform may be determined using a moving regularized least square error minimisation algorithm; however, other deformation methods may be used.

The model of standard human anatomy may comprise a model human skeleton, typically comprises 3D digital data defining said landmarks. This may be stored in a computer readable memory. The stored model of standard human anatomy may be marked to identify at least one of (i) an anatomical marker; and (ii) an anatomical marker identifying an important skeletal region for determining a morphological parameter of the breast. In some examples, deforming the model of the standard human anatomy comprises mapping anatomical markers of the model of standard human anatomy onto the extracted features, corresponding to said anatomical markers for the subject's body

In some examples, the features identified in the image(s) of the subject comprise anatomical landmarks such as the umbilicus and at least one of the shoulder joints. Examples of such landmarks may include, but are not limited to, at least one of shoulder joints (for example head of the humerus), umbilicus, ribs pairwise, mid-points of each rib-pair, umbilicus, spinal vertebra end-points, spinal vertebra mid-points, pose registration axis, marking of spinal vertebras and/or disks index points passing through pose registration axis, spinal vertebra and/or disk index points orthogonal to the umbilicus, end-point of sternum, width and/or height of sternum, jugular notch. In some examples, the location of the umbilicus of the subject may be used to determine the location of the junction between the 3rd and 4th lumbar vertebrae due to the known anthropometric relationship of standard human anatomy between the umbilicus and the junction between the 3rd and 4th lumbar vertebrae.

The at least one image of the subject may comprise the subject in a pre-determined pose. In some examples, the predetermined pose comprises a neutral spine and abduction of the arms at the shoulder, for example with the upper arms extended laterally in the coronal plane. The predetermined pose may comprise the user standing, for example with a neutral spine and abduction of the arms at the shoulder, for example with the upper arms extended laterally in the coronal plane. The elbows may be flexed with the fingers touching each side of the subject's head, for example approximately around the ear.

In some examples, extracting features of at least a portion of the subject's body further comprises extracting edge information of at least a portion of the subject's body from the at least one image. In some examples, extracting features of at least a portion of the subject's body further comprises identifying and measuring points of inflection based on the edge information. In some examples, the points of inflection are used to identify anatomical regions of interest, for example breast root.

In some examples, generating the three-dimensional model of the subject further comprises scaling the three-dimensional model of the subject based on size information obtained from the at least one image. In some examples, the at least one image comprises a reference object, the method comprising determining size information based on an apparent size of the reference object in the at least one image, wherein the actual size of the reference object is known. In some examples, the reference object is positioned on the same plane as at least a portion of the subject's body in the image.

In some examples, determining a morphological parameter of the subject's breast from the three-dimensional model of the subject's body further comprises adjusting a virtual garment to fit the three-dimensional model, and determining at least one of (a) a morphological parameter of the breast based on the adjusted virtual garment, and (b) a parameter of a real garment based on the adjusted garment. In some examples, the virtual garment comprises a support element configured to support at least a portion of the subject's breast. In some examples, adjusting the virtual garment to fit the three-dimensional model comprises deforming a breast part of three-dimensional model of the subject to fit the support element, wherein the deforming is constrained to preserve volume of the breast part of the three-dimensional model.

In some examples, the virtual garment (a) comprises a virtual prosthesis or (b) consists solely of a virtual prosthesis. In some examples, the method comprises identifying a desired morphology of at least one of the subject's breasts and adjusting the virtual prosthesis so that, when the virtual prosthesis is positioned on the three-dimensional model to augment a virtual breast of the model, the augmented virtual breast has the desired morphology. In some examples, the desired morphology comprises a desired shape, and the adjusting the virtual prosthesis comprises deforming the virtual prosthesis while constraining a total volume of the virtual prosthesis. In some examples, the total volume of the virtual prosthesis may comprise the volume of the augmented breast and the prosthesis together.

In some examples, wherein the virtual garment (a) comprises a virtual prosthesis or (b) consists solely of a virtual prosthesis, the method comprises identifying a first morphological parameter of a first one of the subject's breasts, such as volume, wherein the virtual prosthesis corresponds to the second one of the subject's breasts, and deforming the virtual prosthesis under a constraint that the first morphological parameter of the virtual prosthesis matches the first morphological parameter of the first one of the subject's breasts. The method then identifies a second morphological parameter of the adjusted virtual prosthesis. In some examples, the morphological parameter of the virtual prosthesis, such as volume, may comprise the parameter of the second one of the subject's breasts and the prosthesis together.

In some examples, the method comprising determining at least one of (i) a garment size, and (ii) a manufacturing parameter, of at least one of a real prosthesis and a real garment based on the determined morphological parameters. In some examples, the method comprises providing a control signal adapted for controlling a garment provision apparatus to cause the provision of a wearable article, for the subject, based on the determined morphological parameters.

In an aspect there is provided an apparatus for determining morphology of a human breast, the apparatus comprising a processor configured to perform any one or more of the methods described or claimed herein. This apparatus may further comprise an image capture device for capturing a plurality of images of a subject.

In some examples, the apparatus is configured to send a determined morphological parameter, such as a parameter of the subject's breast to a remote device.

In some examples, the apparatus may not comprise an image capture device, for example it may be configured to receive the plurality of images from a remote device, e.g. via a communications network.

In some examples, the apparatus is provided by so-called user equipment (UE), for example a communications device comprising a camera and a communications interface, such as a tablet computer or mobile telecommunications handset.

The apparatus may further comprise a memory configured to store a model of standard human anatomy. In some examples, the memory is further configured to store at least one three-dimensional virtual garment mould.

In an aspect, there is provided a computer program product comprising program instructions configured to program a processor to perform any one or more of the methods described or claimed herein.

In an aspect there is provided a computer implemented method for determining a morphological parameter of a subject's body, the method comprising obtaining a first two-dimensional image showing a first view of the subject and a reference object in a first position relative to the subject, and obtaining a second two-dimensional image showing a view of the subject and a reference object in a second position relative to the subject, wherein the second position is different from the first position. Size information of the subject is then determined based on an apparent size of the reference object in the first image and the second image, and a three-dimensional model of the subject's body is generated based on the size information. A morphological parameter of the subject's body can then be determined from the three-dimensional model of the subject's body.

In some examples, the first view of the subject is different from the second view of the subject.

In some examples, the size information comprises size information corresponding to at least two different planes of a three-dimensional space. In some examples, generating the three-dimensional model comprises applying the size information from the at least two different planes to corresponding planes of the three-dimensional model.

In some examples, the first position of the reference object and the second position of the reference object each correspond to different positions of a predetermined set of anatomical locations. Example anatomical locations may include, but are not limited to, the sternum, on the highest point of one breast, the collar bone, the jugular notch, and ribcage.

In some examples, the predetermined set of anatomical locations each correspond to different planes in a standard three-dimensional model of the human body. In some examples, generating of the three-dimensional model comprises scaling the standard three-dimensional model in the different planes according to corresponding size information for those planes determined from the apparent size of the reference object.

### BRIEF DESCRIPTION OF DRAWINGS

Embodiments of the disclosure will now be described, by way of example only, with reference to the accompanying drawings having like-reference numerals, in which:

FIG. 1 shows an example method for determining morphology of a human breast.

FIGS. 2A and 2B show example apparatus for determining morphology of a human breast, for example configured to perform the example method of FIG. 1.

FIGS. 3A to 3G show an example method for determining morphology of a human breast, for example according to the method of FIG. 1. The method of FIGS. 3A to 3G may also be configured to be performed in the example apparatuses of FIGS. 2A and 2B. FIGS. 3A to 3F show:

in FIG. 3A an illustration of a method for identifying shoulder joint locations;

in FIG. 3B a method for stabilising estimates of shoulder joint locations;

in FIG. 3C a method for identifying the location of the umbilicus;

in FIG. 3D a method for identifying features of the subject's body;

in FIG. 3E a method for generating a 3D model of the subject's body;

in FIG. 3F a method for applying and adjusting a virtual bra to the 3D model of the subject's body; and

in FIG. 3G an example schematic of a virtual bra.

FIG. 4 comprises FIGS. 4A to 4C. FIG. 4A shows an example of pose estimation for determining the pose of the subject from a plurality of images, for example according to the methods of FIGS. 1 to 3. FIG. 4B shows an example stabilisation of the shoulder joints. FIG. 4C shows an example identification and stabilisation of the umbilicus.

FIG. 5 shows an example of curvature estimation based on extracted edge information from an image of a subject, for example according to the methods of FIGS. 1 to 4.

FIG. 6 comprises FIGS. 6A to 6B. FIG. 6A shows an example set of lines marked on the breast used to identify a set of 3D breast control points. FIG. 6B shows an example set of 3D breast control points that are identified and extracted from at least two 2D images and used to characterise the subject's breasts in three-dimensions, for example according to the methods of FIGS. 1 to 5.

FIG. 7 shows an example image of a subject in a pre-determined pose, for example for use in the methods of FIGS. 1 to 6.

FIG. 8A shows two example images of a subject comprising a reference object, for example for use in the methods of FIGS. 1 to 6 or FIG. 10. FIGS. 8B and 8C show example methods of deriving size information from a plurality of images comprising a reference object, for example the images shown in FIG. 8A.

FIG. 9 shows an example method for determining a morphological parameter of a subject's body, for example for use with the example apparatuses of FIGS. 2A and 2B.

FIGS. 10A to 10I show a selection of example morphological parameters of the breast which may be determined using any of the methods described herein.

FIG. 11 illustrates an example method of determining one or more measurements related to the breast gap of a subject.

FIGS. 12A to 12E illustrate a 3D model from different viewpoints of a subject.

FIG. 13 shows an example apparatus for providing a manufactured wearable garment for a human subject, for example configured to perform the method of FIG. 14.

FIG. 14 shows an example method for providing a manufactured wearable garment for a human subject, for example for use with the example apparatus of FIG. 1.

### SPECIFIC DESCRIPTION

In the context of the present disclosure other examples and variations of the apparatus and methods described herein will be apparent to a person of skill in the art.

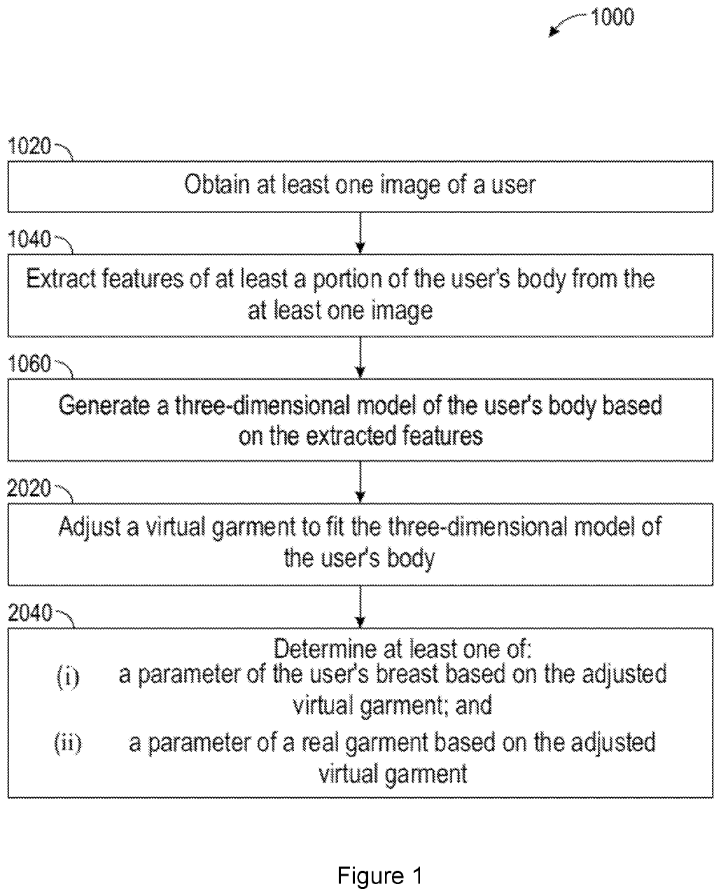

FIG. 1 shows an example method (1000) for determining morphology of a human breast. Firstly, at least one image is obtained of the subject (1020). In this example, the at least one image comprises a plurality of two-dimensional images.

Features of at least a portion of the subject's body which correspond to a model of standard human anatomy are identified and extracted from the plurality of images of the subject (1040). The extracted features of at least a portion of the subject's body comprise anatomical markers. In this example, the anatomical markers comprise the shoulder joints and umbilicus. Identification of the anatomical markers, for example, the position of the shoulder joints and umbilicus, may be determined using machine learning based methods, such as deep learning, or any of contour, curvature, and texture analysis. However, where the umbilicus cannot be identified (e.g. when obscured by a garment), the method may proceed only identifying the shoulder joints.

Spatial data describing the relative locations of the anatomical markers extracted from the plurality of images is then used to generate a three-dimensional model of the subject's body (1060). The spatial data extracted from the plurality of images may be in the form of two-dimensional spatial coordinates; the two-dimensional spatial coordinates are transformed into three-dimensional coordinates using the correlation between the relative locations of the anatomical markers between the plurality of images, for examples by using projective geometry. The three-dimensional coordinates are used to generates the three-dimensional model of the subject's body (1060). To generate the model of the subject's body (1060), a model of the standard human anatomy is deformed by mapping corresponding anatomical markers of the model of standard human anatomy onto the extracted anatomical markers of the subject. The model of a standard human anatomy is stored in the memory. The stored model of standard human anatomy is marked, for example using spatial coordinates, to identify at least the anatomical markers corresponding to the anatomical markers identified from the plurality of images, in this case the shoulder joints and the umbilicus. The marked model of standard human anatomy may comprise vertex and edge information, wherein vertices comprise spatial coordinates and edges comprise an association between the vertices. The model of a standard human anatomy is deformed so that the relative locations of the shoulder joints and umbilicus of the model coincide with the relative locations of the shoulder joints and umbilicus of the subject, as identified from the plurality of images. This is achieved by applying a spatial transform to the model of standard human anatomy such that the spatial data describing the relative positioning of the anatomical markers of the standard model is transformed to reflect the spatial data describing the relative locations of the anatomical markers identified from the subject's body. This maps the two-dimensional marker points from the two-dimensional images to three-dimensional skeletal key points by establishing their interrelation in three-dimensional space, for example using projective geometry and known anthropometric relationships. Identifying the location of the umbilicus may be advantageous, as it allows the spatial transform to be based on the anthropometric relationship of standard human anatomy whereby the seat of the umbilicus has a standard vertical level of the junction between the 3^{rd} and 4^{th} lumbar vertebrae.

At least one morphological parameter of the subject's breast is then determined from the three-dimensional model of the subject's body. To do this, a digital model of a garment (“a virtual garment”) is adjusted to fit the three-dimensional model of the subject's body (2020).

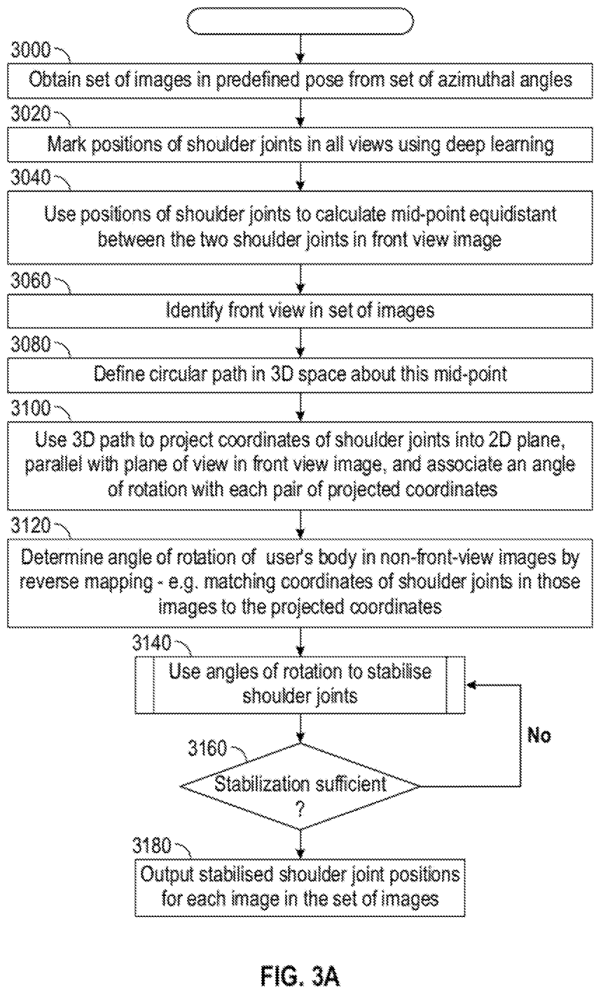

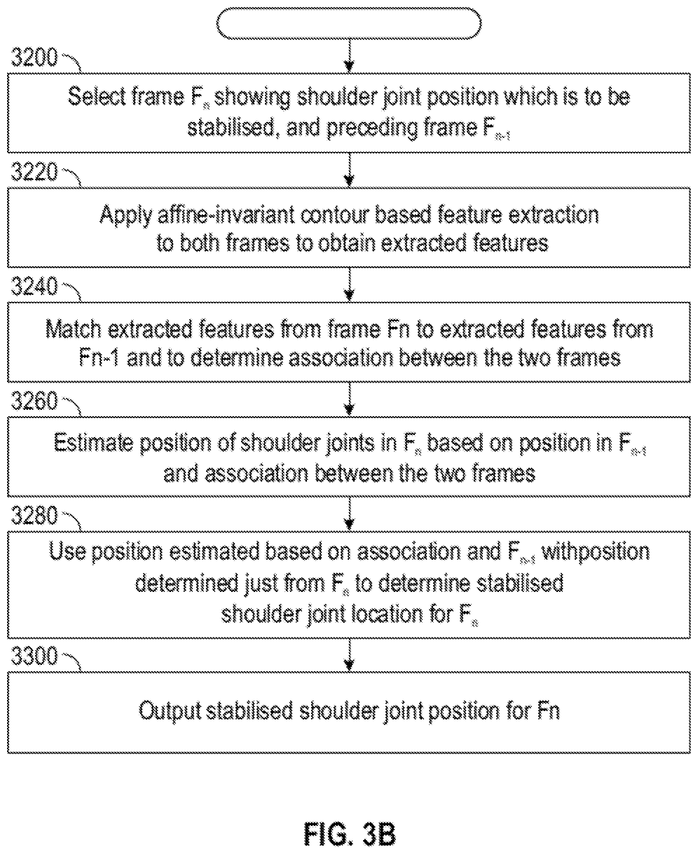

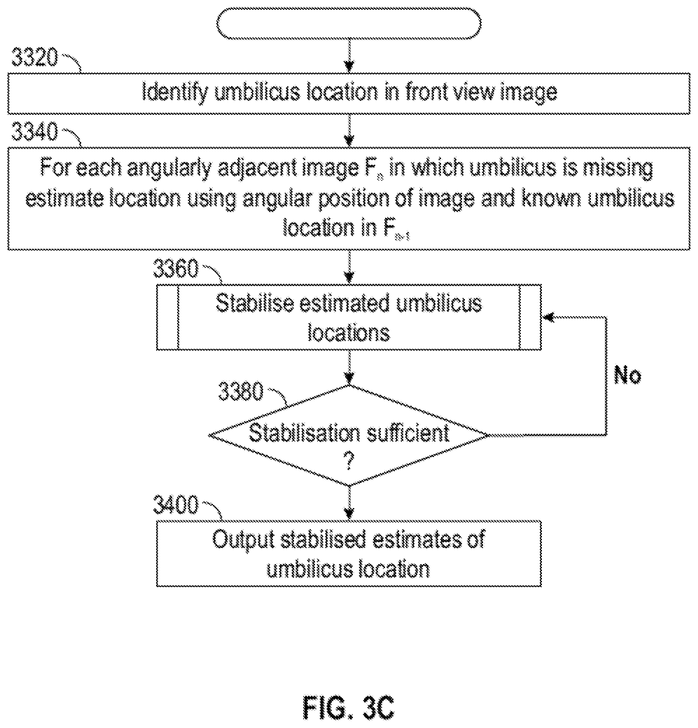

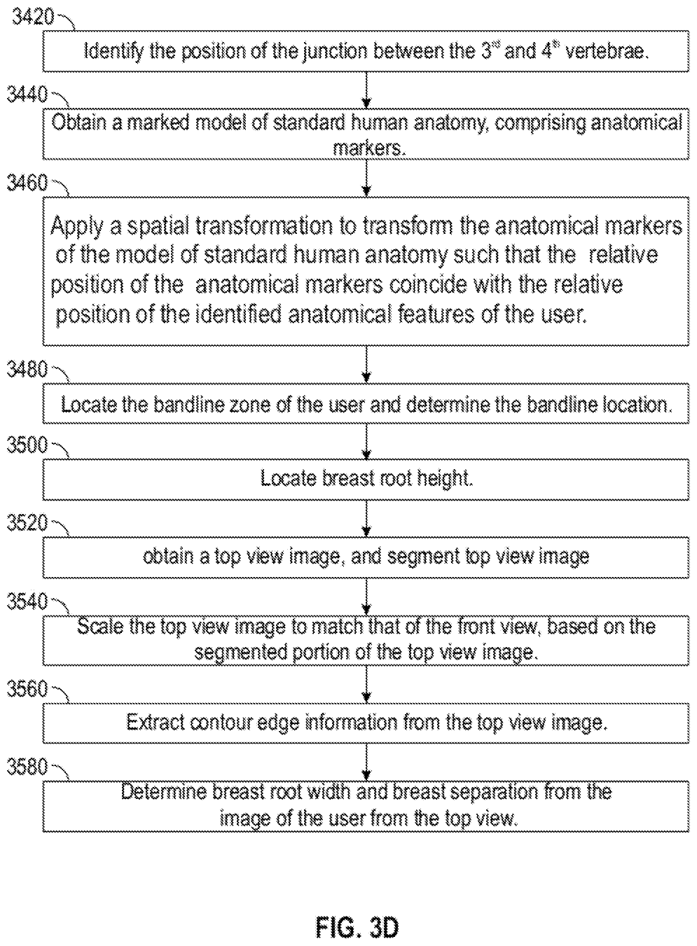

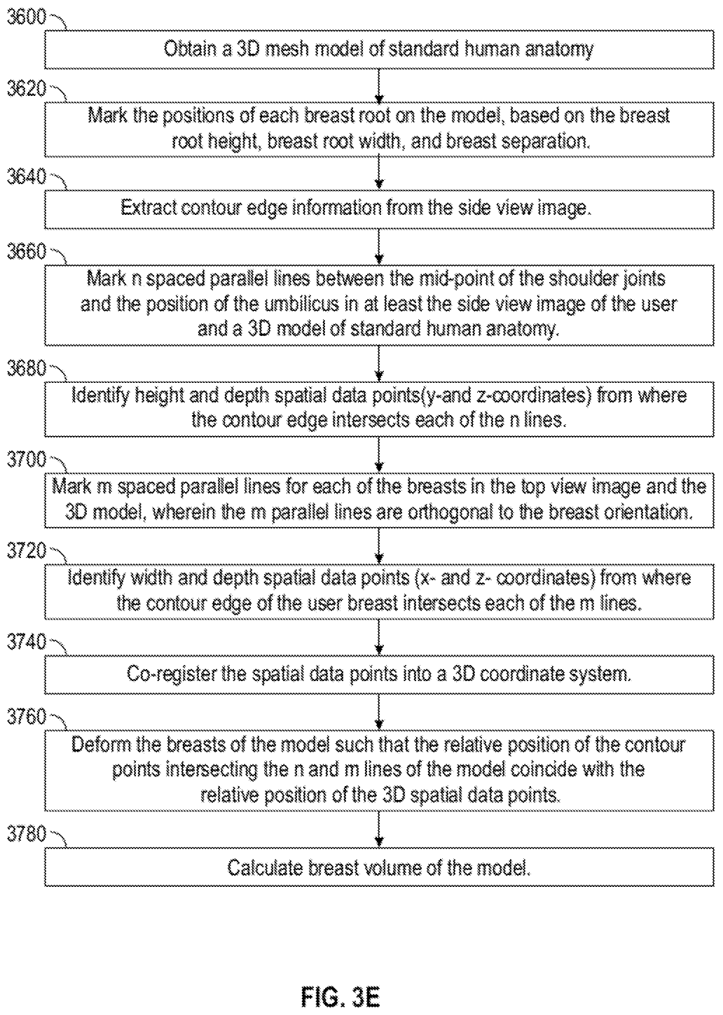

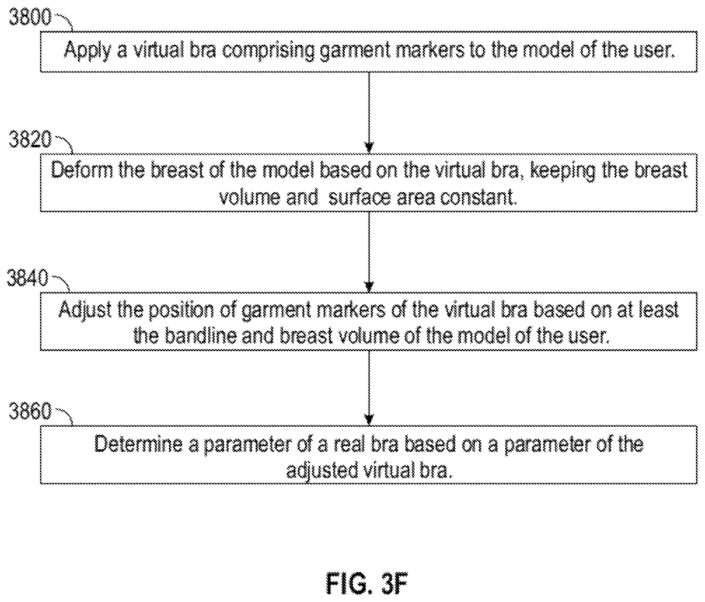

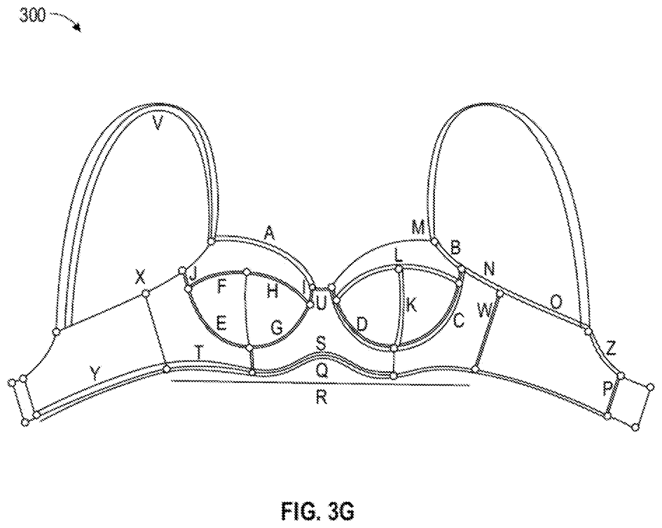

Based on this adjusted garment, a parameter of the subject's breast is determined as a parameter of a real garment corresponding to that virtual garment (2040). This may be done by applying a virtual garment mould to the three-dimensional model of the subject. The virtual garment may be applied to the three-dimensional model of the subject by identifying anatomical markers of the model and aligning the virtual garment to coincide with the identified anatomical markers. The three-dimensional virtual garment mould comprises data defining a digital model of the garment, which also includes a plurality of garment markers. For example, in the case of fitting a garment such as a bra, the garment markers could correspond to the end points of the seam line of a bra, and/or curves of the bra such as the underwire. An example virtual bra is discussed in more detail in relation to FIG. 3G.

To apply the virtual garment mould, first a transformation is calculated which deforms the three-dimensional model of the part of the subject on which the garment is to be “worn” so that it matches the shape of the virtual garment. This deformation is performed under the constraint that the volume and surface area of that part of the body in the three-dimensional model is preserved. The applied virtual garment is then adjusted, for example by adjusting the relative placement of garment markers, to help fit the virtual garment correctly as on a real subject. For example, any outlier garment markers are adjusted to be placed in the associated relative placement on the three-dimensional model of the subject. The fit of a real garment may then be determined by matching the distance between and/or the relative positioning of the garment markers of the virtual garment to a database, wherein the database comprises known distances between and/or the relative positioning of garment markers for real garments. The fit of a real garment is determined by the similarity of the garment marker measurements of the virtual bra to those of a real garment, wherein more similar measurements correspond to a better fit.

In this example, determining at least one of: (i) a parameter of the subject's breast based on the adjusted virtual garment; and (ii) a parameter of a real garment based on the adjusted virtual garment (2040) comprises determining parameters based on the relative placement of the adjusted garment markers. In this example, the garment markers may form the determinative edges of the virtual garment, wherein the determinative edges form an association between marker points specifically defined for describing the breast, the true distance between garment markers is calculated to determine a parameter either of the subject's breast, or of a real garment. The adjusted garment marker data is then used to determine a morphological parameter of the breast, for example, at least one of breast volume, breast shape (for example tear-drop, full-on-top, heavy-on bottom, dripping etc.), breast root topography, breast orientation, breast separation, presence of side breast, side breast volume, side breast area, breast tissue distribution, breast 3D control points, bandline length, bandline location, breast-garment association, garment size, breast root location, breast root height and/or width, breast tissue strength.

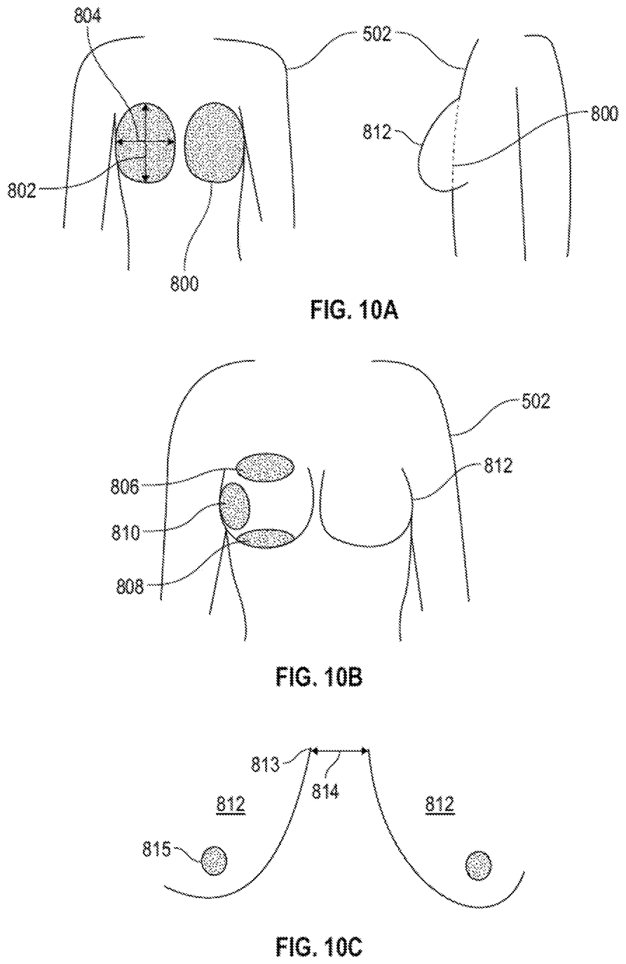

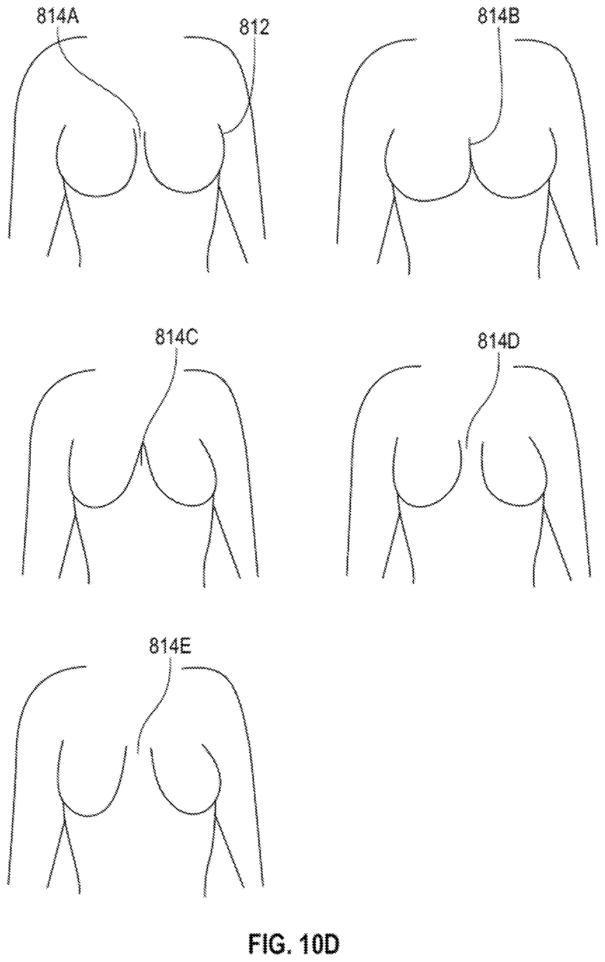

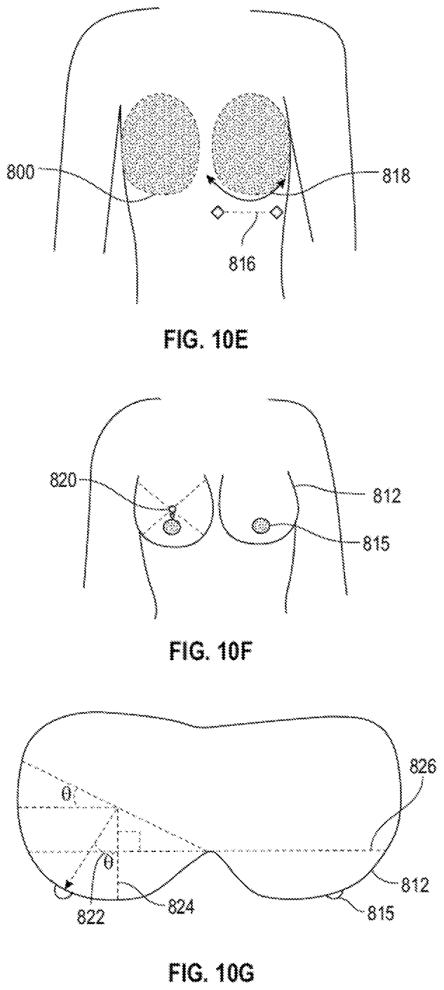

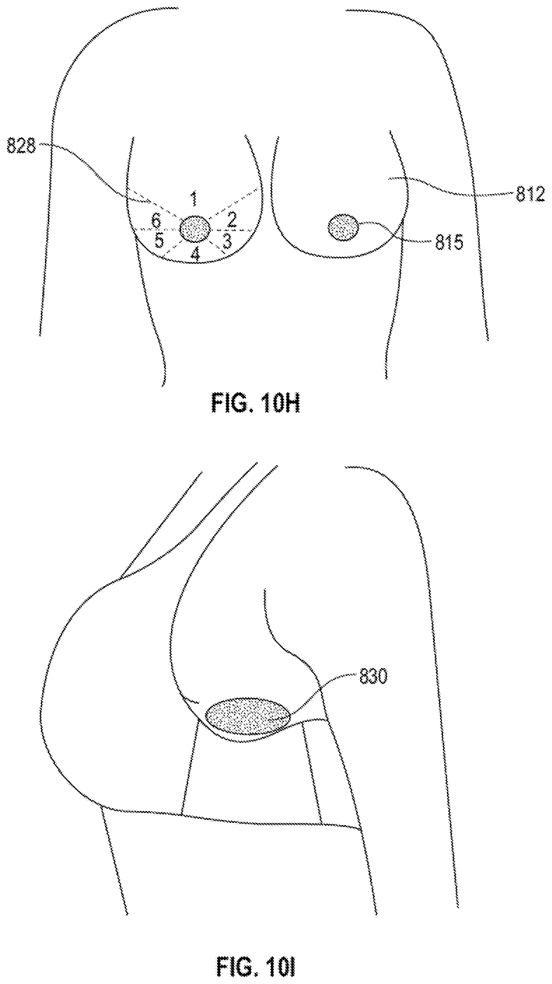

Example morphological parameters are discussed in more detail below, in relation to FIGS. 10A to 10I.

In this example, the virtual garment comprises a support element configured to support at least a portion of the subject's breast, for example a virtual bra comprising support cups. Adjusting the virtual garment to fit the three-dimensional model comprises deforming a breast part of three-dimensional model of the subject to fit the support element, wherein the deforming is constrained to preserve volume and surface area of the breast part of the three-dimensional model. Where the three-dimensional model of the subject is a mesh model, volume and surface area of the mesh may be computed using a triangulation and tetrahedron approach. The adjusted garment markers represent spatial data describing the shape and size of the subject, including the subject's breast. The spatial data is then output to determine a parameter of the subject's breast.

In the example described above in reference to FIG. 1, the at least one image comprises a plurality of two-dimensional images, however it will be appreciated by the skilled person having read the present disclosure that in other examples the at least one image may comprise one two-dimensional image, one three-dimensional image, a plurality of three-dimensional images, or a plurality of both two-dimensional images and three-dimensional images.

In some examples, the obtained image(s) may additionally be pre-processed in order to produce an enhanced version of the image data to increase the accuracy and validity of feature extraction. Pre-processing may include at least one of brightness correction, contrast enhancement, perspective correction, shadow removal, background segmentation, and region of interest detection including cropping.

The example described above, in reference to FIG. 1, refers to the use of the shoulder joints and umbilicus as anatomical markers, however it will be appreciated by the skilled person having read the present disclosure that other anatomical markers may be used, for example, including but not limited to, at least one: of shoulder joints (for example head of the humerus), umbilicus, ribs pairwise, mid-points of each rib-pair, umbilicus, spinal vertebra end-points, spinal vertebra mid-points, pose registration axis, marking of spinal vertebras and/or disks index points passing through pose registration axis, spinal vertebra and/or disk index points orthogonal to the umbilicus, end-point of sternum, width and/or height of sternum, jugular notch.

The example described above, in reference to FIG. 1, refers to marking the stored model of standard human anatomy to identify at least the anatomical markers corresponding to the anatomical markers identified from the plurality of images. In some examples, the stored model of standard human anatomy comprises additional anatomical markers indicating important skeletal regions used for determining a morphological parameter of the breast, for example, including but not limited to, at least one of shoulder joints (for example head of the humerus), umbilicus, ribs pairwise, mid-points of each rib-pair, umbilicus, spinal vertebra end-points, spinal vertebra mid-points, pose registration axis, marking of spinal vertebras and/or disks index points passing through pose registration axis, spinal vertebra and/or disk index points orthogonal to the umbilicus, end-point of sternum, width and/or height of sternum, jugular notch. In some examples, the additional anatomical markers may be used for positioning the virtual garment in the correct position on the three-dimensional model of the subject. For example, at least a portion of the garment markers may be translated to align/coincide with at least a portion of the anatomical markers during application of the virtual garment.

The example described above in reference to FIG. 1 describes the use of a virtual garment to determine a parameter of the subject's breast. However, in some examples, a parameter of the subject's breast may be determined directly from the three-dimensional model of the subject's body, without applying and adjusting a virtual garment. In these examples, the parameter of the subject's breast may be determined using spatial data of the three-dimensional model of the subject's body. For example, the location of the bandline of the subject can be determined directly from the plurality of images of the subject based on identifying rib-placement of the subject based on the anatomical markers derived from the standard model of human anatomy scaled to the subject. This information is registered on the three-dimensional model of the subject, based on the relative placement of anatomical markers from the plurality of images. Rib-placement of the subject may be determined based on at least one additional anatomical marker describing the estimated position of the ribs, wherein the estimated position is derived from the marked position of the ribs on the model of standard human anatomy. In this example, the bandline zone is identified between the 4^{th} to 8^{th} rib pairs. The bandline position is then refined by estimating the position of the bandline specific to the subject using a machine learning module based on subject variables including at least one of breast heaviness, breast curvature, age, width, height. In this example, the subject variables used in the machine learning model are obtained from a subject questionnaire, for example wherein the subject manually inputs at least one of breast heaviness, breast curvature, age, width, height. Bandline length can then be calculated based on the perimeter of a cross section of the subject's body in the horizontal plane at the bandline location.

The example described above in reference to FIG. 1 describes determining the parameter of the subject's breast based on adjusting a virtual garment, however it will be appreciated by the skilled person having read the present disclosure that determining the parameter of the subject's breast may comprise a combination of determining parameters directly from the three-dimensional model of the subject's body, and determining parameters based on the adjusted virtual garment. In some examples, the determined parameters represent different parameters of the subject's breast. In some examples, at least one parameter of the subject's breast determined directly from the three-dimensional model of the subject's body is the same parameter as at least one parameter of the subject's breast is determined based on the adjusted virtual garment, for example to validate the determined value of the parameter.

The example described above in reference to FIG. 1 refers to the use of a virtual bra mould, however it will be appreciated by the skilled person having read the present disclosure that other virtual garments may be used. These may include other virtual garments that comprise a support element and/or cup or moulding (e.g. clothing that holds its own shape) including, but not limited to, sports bras, swimwear, shape wear, and other garments comprising a support element. In some examples, the support element may comprise a breast cup.

It will be appreciated by the skilled person having read the present disclosure that other virtual garments can include those which (a) comprise a virtual prosthesis or (b) consist solely of a virtual prosthesis. In these examples, adjusting the virtual garment to fit the three-dimensional model of the subject's body (2020) may comprise identifying a desired morphology (typically pre-determined per cup size, where there is a three-dimensional baseline for each cup size) of at least one of the subject's breasts, and adjusting the virtual prosthesis so that, when the virtual prosthesis is positioned on the three-dimensional model to augment a virtual breast of the model, the augmented virtual breast has the desired morphology. In some examples, the desired morphology comprises a desired shape, and adjusting the virtual prosthesis further comprises deforming the virtual prosthesis while constraining a total volume and surface area of the desired augmented breast, wherein the volume of the augmented breast includes the volume of the virtual prosthesis. Deforming the virtual prosthesis may include adjusting the relative position of garment markers, wherein the garment markers form the determinative edges of the virtual prosthesis. The prosthesis size may then be output. Prosthesis size may comprise features including volume, height, depth, and width of the prosthesis. In some examples, the output prosthesis size is dependent on the product sizing provided by the manufacturer. The size of the virtual prosthesis is matched to existing manufacturing parameters of real prostheses and the relevant product size is determined and output for said manufacturer.

In other examples wherein the virtual garment (a) comprises a virtual prosthesis or (b) consists solely of a virtual prosthesis, adjusting the virtual garment to fit the three-dimensional model of the subject's body (2020) comprises identifying at least one first morphological parameter of a first one of the subject's breasts, for example, but not limited to breast volume or shape, wherein the virtual prosthesis corresponds to the second one of the subject's breasts, and deforming the virtual prosthesis under a constraint that the at least one first morphological parameter of the virtual prosthesis matches the at least one first morphological parameter of the first one of the subject's breasts.

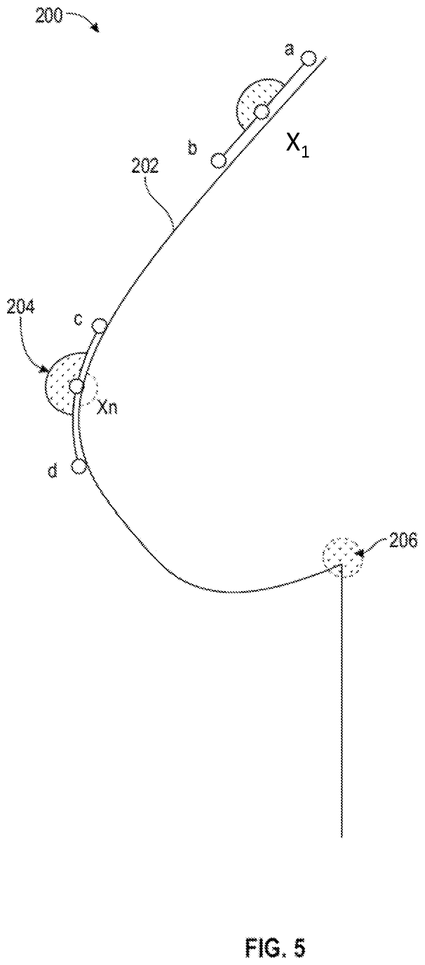

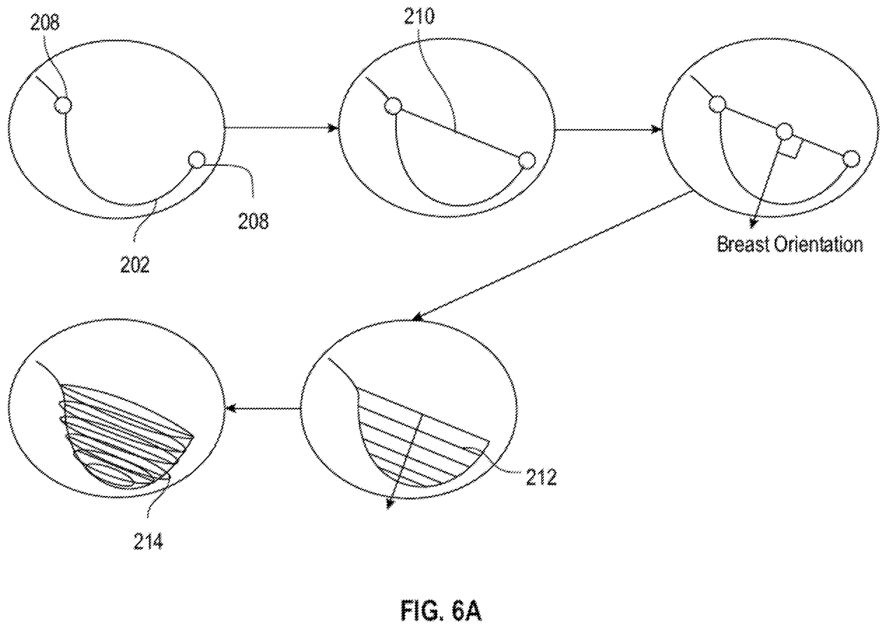

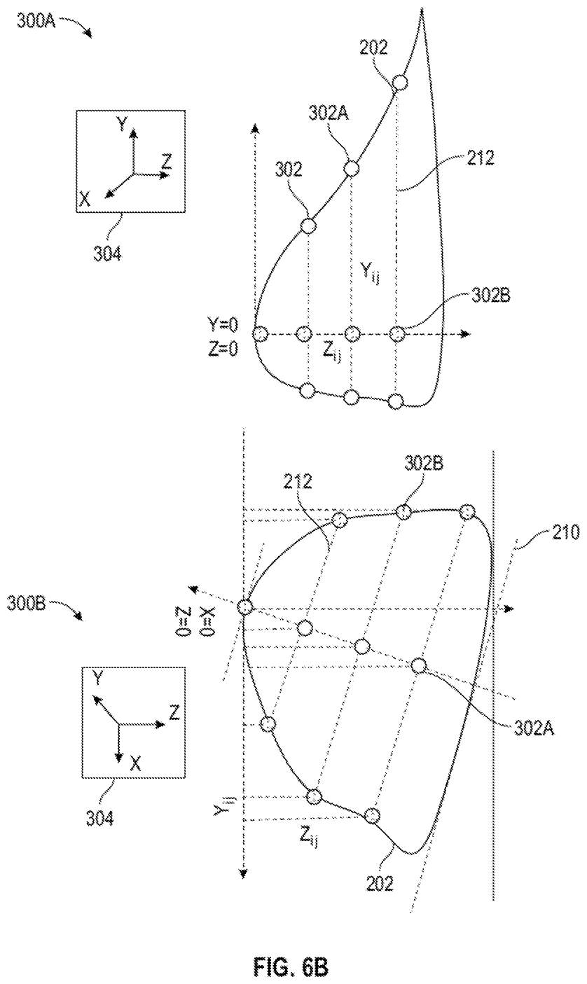

For example, when the first morphological parameter of the first one of the subject's breasts is shape, the shape of the first one of the subject's breasts may be characterised using key points, for example according to the methods discussed in more detail in FIGS. 5 and 6.

The virtual prosthesis is then deformed via a spatial transformation such that the garment markers of the virtual prosthesis are transformed to mirror the corresponding key points of the first one of the subject's breasts when the virtual prosthesis is positioned on the three-dimensional model. A second morphological parameter of the adjusted virtual prosthesis may then be identified. The prosthesis size may then be output, wherein the prosthesis size comprises at least the second morphological parameter. Prosthesis size may comprise features including volume, height, depth, and width of the prosthesis. In some examples, the output prosthesis size is dependent on the product sizing provided by the manufacturer. The size of the virtual prosthesis is matched to existing manufacturing parameters of real prostheses and the relevant product size is determined and output for said manufacturer. In some examples, wherein the virtual garment comprises a virtual prosthesis and a garment element, the surface area of the garment should additionally fit with respect to the size of the first one of the subject's breasts, in addition to size of the second one of the subject's breasts, comprising the virtual prosthesis.

In some examples, the determined morphological parameters are output to a product recommendation module. The product recommendation module then provides a real garment based on the determined morphological parameters.

In some examples, determining a morphological parameter of the subject's breast from the three-dimensional model of the subject's body further comprises determining at least one of (i) a garment size, and (ii) a manufacturing parameter, of at least one of a real prosthesis and a real garment based on the determined morphological parameters.

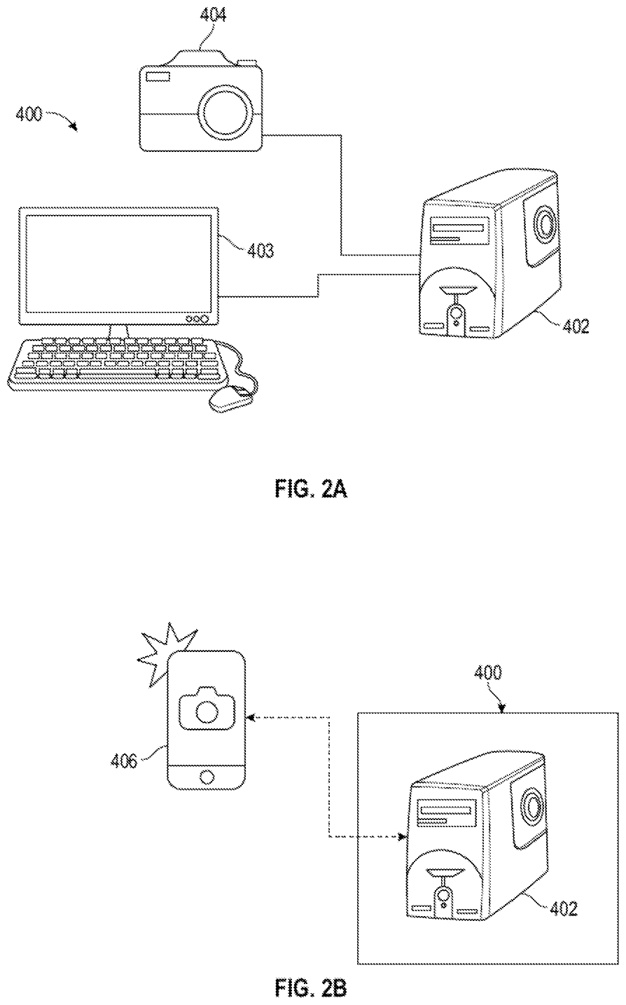

FIG. 2A shows an example apparatus 400 for determining morphology of a human breast, comprising a processor 402 configured to perform the example method of FIG. 1.

In the example shown in FIG. 2A, the apparatus 400 comprises a memory, coupled to the processor 402, configured to store the standard model of human anatomy and the virtual garment mould. In this example, the apparatus 400 further comprises an image capture device 404, for example a camera, configured to capture a plurality of images of a subject. The processor 402 is then configured to obtain at least one image from the image capture device 404 for further processing. A display 403 is configured to display the output from the processor 402. In some examples, the apparatus 400 as shown in FIG. 2A may represent a user equipment device comprising a camera, such as a smartphone, tablet, or other personal computing device with an integrated or separate image sensor.

FIG. 2B shows another example apparatus 400 for determining morphology of a human breast, which will now be describe in more detail below.

The apparatus shown in FIG. 2B comprises a processor 402 configured to perform the example method of FIG. 1. In this example, the apparatus 400 further comprises a memory, coupled to the processor 402, configured to store the standard model of human anatomy and the virtual garment mould. In this example, the processor is configured to send at least one of a parameter of the subject's breast, a garment size, and a manufacturing parameter of a real prosthesis or garment based on the determined morphological parameters of the subject's breast to a remote device 406. In some examples, the apparatus 400 is configured to receive at least one image of the subject from a remote device 406. In some examples, the communication module may communicate using an Internet of Things (IOT) gateway. In the example shown, the remote device 406 may represent a user equipment device comprising a camera, such as a smartphone, tablet, or other personal computing device. In some examples, the processor 402 may be configured for wireless communication with the remote device 406.

FIGS. 3A to 3F show an example method for determining morphology of a human breast, for example according to the method of FIG. 1.

This method is performed by the apparatus described with reference to FIG. 2A, however the method may also be performed by the apparatus described with reference to FIG. 2B.

An example method of analysing the positioning of the shoulder joints is shown in more detail in FIG. 3A, which will now be described in more detail.

The position of the shoulder joints may be used in the methods described herein to estimate the user's pose. The method described with reference to FIG. 3A also provides a way to identify and extract anatomical markers from the plurality of images of the user, as described above with reference to FIG. 1. However, it will be appreciated by the skilled person having read the present disclosure that other methods of pose estimation and extracting pose information, and other anatomical markers and methods of extraction, may also be used.

First a set of images of a human subject (or user) is obtained (3000). The images show the subject standing, e.g. with their spine in a neutral position, and with his or her arms abducted at the shoulders. The arms may be flexed so that the subject's hands can be placed on his or her head. The images include a set of views, each taken from a different viewpoint of the subject—for example from a different azimuthal angle so that the images show a front view and a set of other views, such as a rear view and/or a right profile and/or a left profile, and/or a number of intermediate or oblique views angularly spaced between the front and rear.

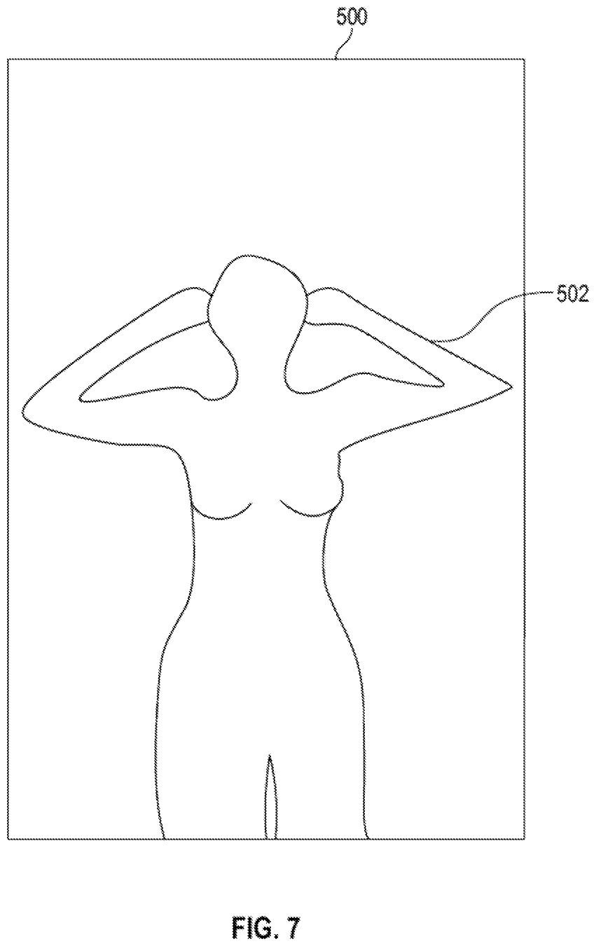

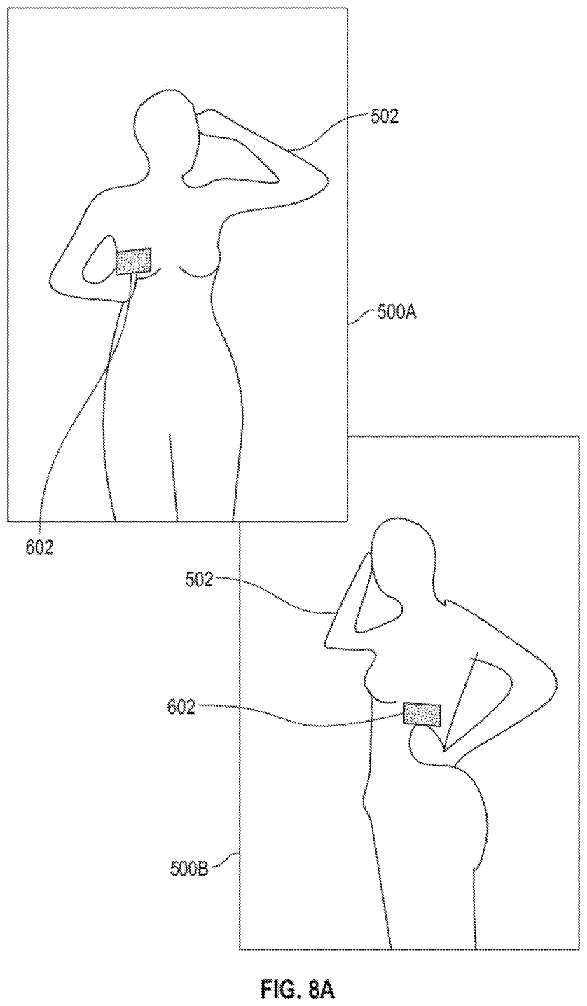

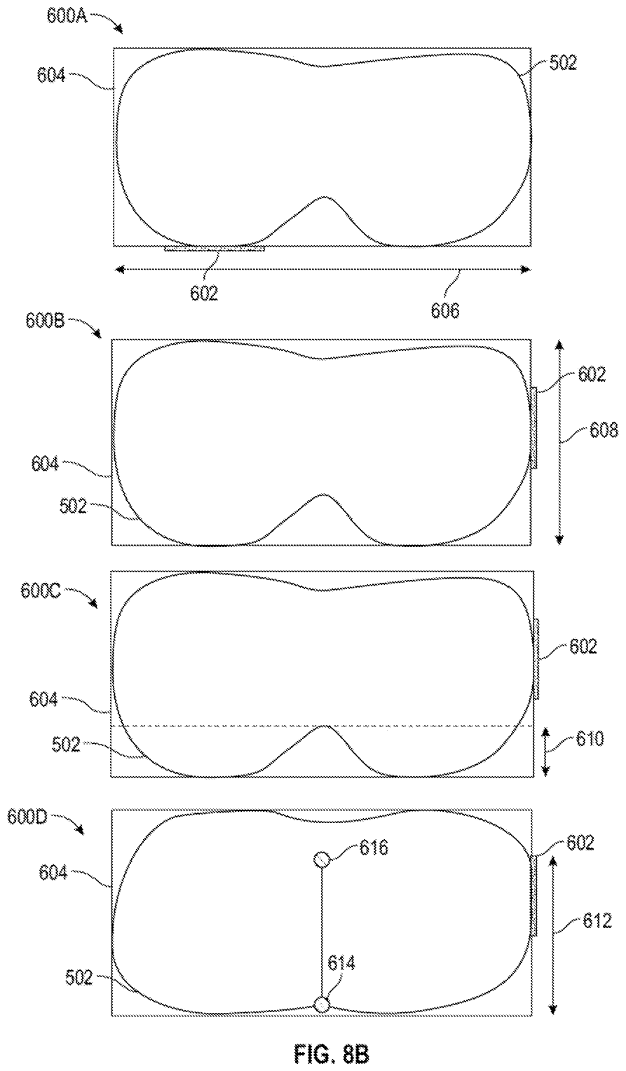

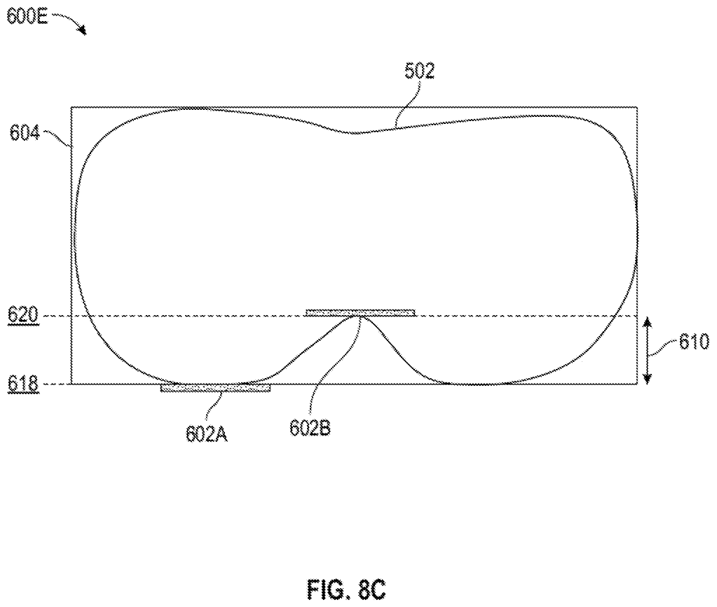

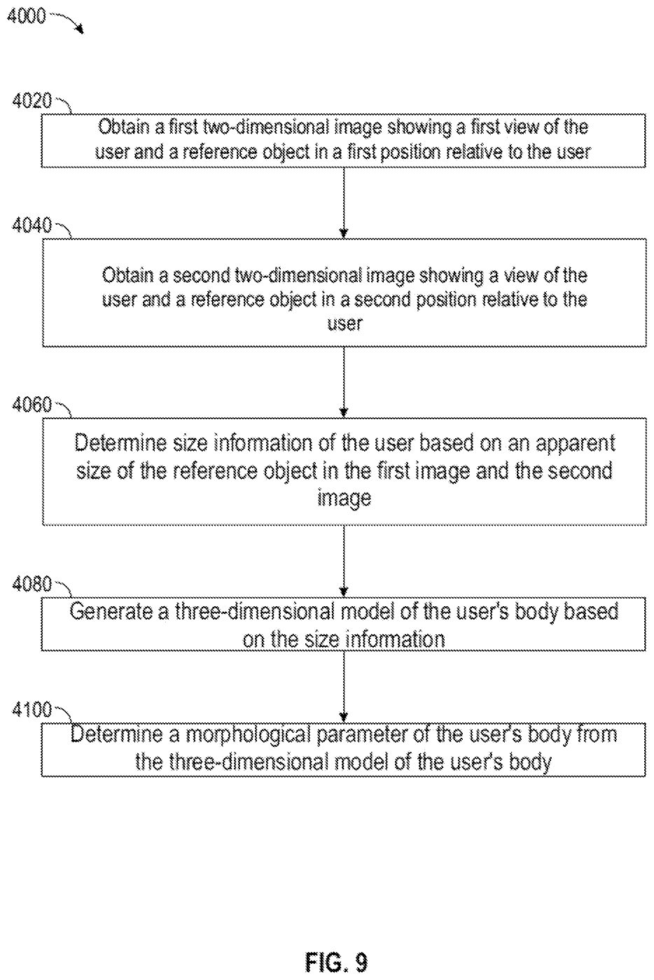

The processor 402 obtains camera information, which may be provided in metadata accompanying the images, for example as part of the image file format e.g. in a file header which may comprise the angular field of view of the camera. The processor 402 is configured to use such camera information to determine the focal length of the camera. The distance of the camera from the projection plane (the object plane) is then calculated, based on the focal length of the camera. This may be used to determine size information of the user, e.g. for use in converting image/pixel measurements into real world measurements. However, the skilled person will appreciate in the context of the present disclosure that other methods to extract size information may be used, for example including the use of a reference object, for example as discussed in more detail in relation to FIGS. 8 to 9, or a combination of the use of a reference object and extracting camera information.

The processor 402 analyses the images to identify an approximate location of the shoulder joints in each image of the set of images (3020). The processor 402 may be configured to do this by applying a deep learning algorithm such as a Real-Time and Accurate Full-Body Multi-Person Pose Estimation & Tracking System, for example AlphaPose (RMPE: Regional Multi-person Pose Estimation; Fang, Xie, Tai, Lu; ICCV; 2017; https://www.mvig.org/research/alphapose.html). Other feature identification methods may be used, for example contour, curvature, or template-matching techniques.

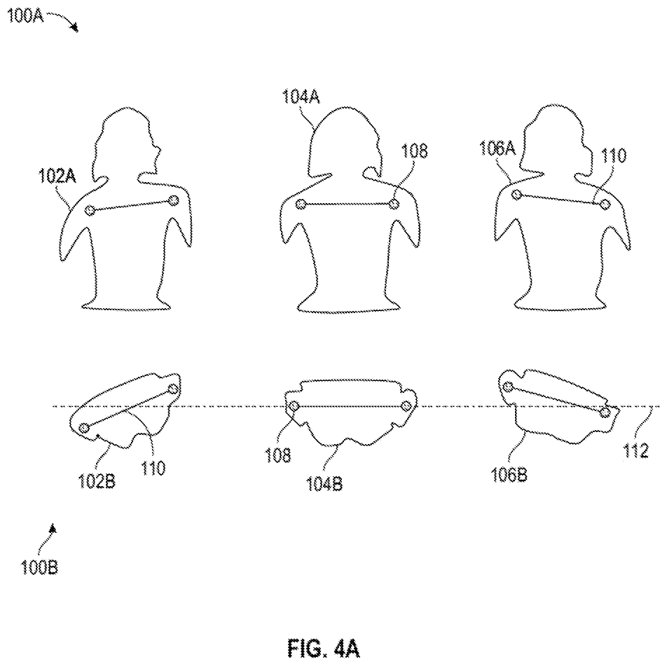

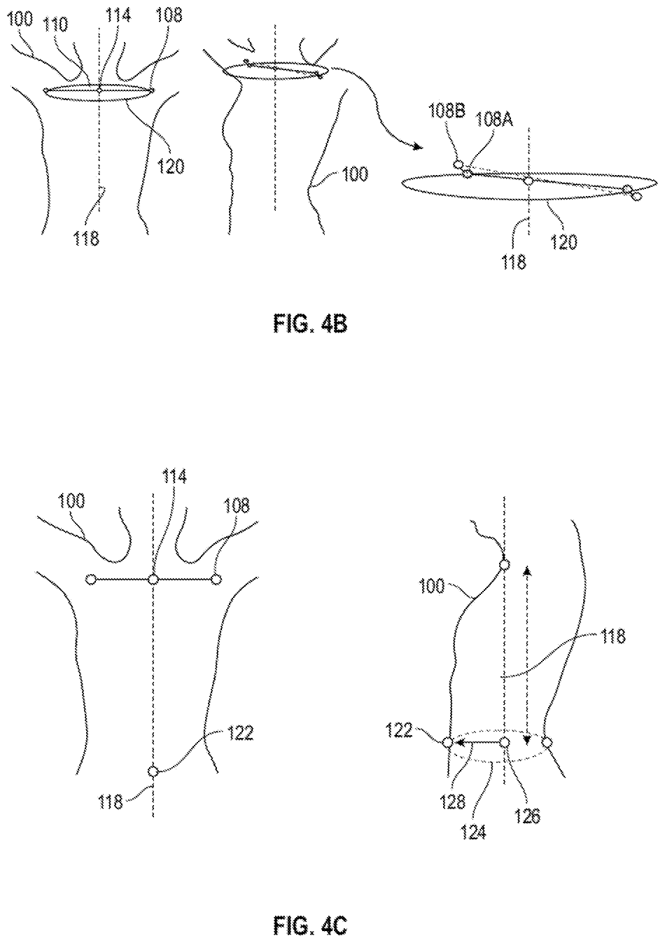

The processor then analyses the images to identify the centre of rotation of the subject's body, and this may be done by identifying a pose registration axis wherein the pose registration axis passes through the mid-point between the shoulder joints. It is therefore assumed that rotation of the user is a rotation about the pose registration axis, and that the pose registration axis lies on the projection plane. Other ways of calculating the pose registration axis may also be used. For example, by the processor identifying the outline of the body in each image, and then for each row of pixels (horizontal) in the image identifying the average position of the subject in that row, and then finding the straight line which best fits these average positions in each row. This may provide an approximation to the pose registration axis in each of the images. The processor 402 then identifies a front view (3060) image from the set of images, or at least the image which is closest to a front view of the subject. This may be done by the processor selecting the image in which the distance between the locations of the shoulder joints in that image is greatest, for example as shown in more detail with reference to FIG. 4A. It may also be done by selecting the image in which the line between the shoulder joints is closest to horizontal and/or closest to perpendicular to the pose registration axis.

The processor 402 then defines a circle in 3D space (3080)—e.g. by calculating a set of 3D coordinates. This circle corresponds to the rotation of the shoulder joint locations identified in the front view image (3060) about the midpoint calculated in the preceding step (3040), for example as shown in more detail with reference to FIG. 4B. This rotation may be a rotation in a horizontal plane (e.g. parallel to the rows of pixels or perpendicular to the pose registration axis). The processor 402 then calculates the projection of this circle onto the 2D-plane parallel with the front view image for each of a set of angular positions distributed about this circle (3100)—for example these angular positions may be regularly spaced such as at 1° or 2° increments. The processor thus generates an association between a set of angles, and a corresponding set of projected coordinates. These projected positions correspond to the expected position of the shoulder joints when the subject is standing in the relevant angular position.

Then, for each image in the set of images of the subject, the processor 402 uses the shoulder joint locations identified by the deep learning approach described above and finds the projected positions which match these most closely, thereby assigning an angular position to each image of the subject (3120). In the event that one of the shoulder joint locations is missing from an image, the processor 402 is configured to provide an estimate of the missing shoulder joint location. It does this based on the angular position information identified in the preceding step of the method. In particular, the processor determines a predicted location of the missing shoulder joint based on its location in at least one other image in the set of images (such as the image(s) at the nearest adjacent angular locations). This may be done by the processor interpolating between known shoulder joint locations of the other images to identify its likely position in the image from which it is missing. This interpolation may be done by fitting a curved path, such as an ellipse, to the known shoulder joint locations and then selecting a location on this curved path using the angular position of the image from which the shoulder is missing. The curved path corresponds to the circle of rotation viewed with respect to the position of the camera. The location of a missing shoulder joint can thus be estimated based on these angular positions and the other images of the set.

The processor 402 may also use this assignment of angular position of each of the images to improve the estimate of the shoulder joint locations (3140) in the manner described below with reference to FIG. 3B.

This method of stabilising shoulder joint locations is repeated iteratively until the processor determines that a stability threshold has been reached (3160), for example when the joint location doesn't change by more than a threshold amount between iterations, at which point the shoulder joint locations can be provided for use in further methods of the present disclosure and/or output (3180) to a resource such as a memory and/or for use in the co-registration of the 2D images of the subject with a 3D model of the standard human anatomy—such as by deforming that 3D model onto the shoulder joint locations.

The method of stabilising the shoulder joint locations mentioned above with reference to FIG. 3A will now be explained by reference to FIG. 3B, which will be described in more detail below.

The processor 402 selects the image Fₙ in which the shoulder joint locations are to be stabilised, and it also selects the “preceding” frame Fₙ₋₁ (3200). It will be appreciated in the context of the present disclosure that this need not be the temporally preceding image, but may instead simply be an angularly adjacent image from the set of images—e.g. the image in which the view of the subject has the closest angular position (as defined above) to the image Fₙ.

The processor 402 then applies a feature extraction analysis to both images Fₙ₋₁ and Fₙ. This feature extraction analysis may be an affine invariant contour based feature extraction (3220). For example, wherein the use of the contour (i.e. the shape of the shoulders) is able to detect the shoulder joints. This approach is invariant to transformations such as rotation, affine transforms, and scaling. Other methods of feature extraction analysis may also be used. For example, a template based approach or a marker based approach where any marker on the user's shoulder, such as a marker on the user's garment (e.g. shoulder straps), or image annotation could be used to identify the shoulder.

The feature extraction analysis thus provides, for each image Fₙ₋₁ and Fₙ an identifiable set of features and a corresponding set of locations for each feature in each of the two images. The processor then determines an association, such as a spatial transform, between the image Fₙ and the image Fₙ₋₁ (3240). The association describes how the set of locations for each feature are related and can be transformed from the corresponding set of locations in the image Fₙ₋₁ to the image Fₙ. This transformation is based on the angular positions of the images to locate the features in 3D space, for example based on the projected circle corresponding to the rotation of the shoulder joint locations. In some examples, the transformation is also based on scaling information and camera viewpoint corrections. The transformation may also correct for oscillation of the subject in the x-direction, parallel to the plane of the camera. Oscillation in the x-direction is determined by tracking the position of the mid-point of rotation.

The processor 402 then determines a predicted shoulder joint location in the image Fₙ based on this association and the shoulder joint locations in the other image Fₙ₋₁ (3260).

The processor 402 then combines the predicted shoulder joint location (predicted from Fₙ₋₁) with the current estimate of shoulder joint location for the image Fₙ (determined by feature analysis) to provide an updated estimate of the shoulder joint location in Fₙ (3280). This update may be performed using a weighted combination, for example wherein weighting is based on the probability of the shoulder joint location.

The updated shoulder joint location is then output from this process (3300), e.g. output to a resource such as a memory for use as described above with reference to FIG. 3A.

At this stage, the processor 402 has determined, based on the set of images, a set of estimates of the shoulder joint locations with respect to a centre of rotation of the subject. The processor 402 can combine these estimates to provide a single properly stabilised estimate of the two shoulder joint locations and/or also an estimate of the pose registration axis, wherein the pose registration axis is determined to pass through the mid-point between the shoulder joints.

FIG. 3C provides a schematic illustration of a method of identifying the location of the subject's umbilicus, which will now be described in more detail below.

The umbilicus is first identified in the front view image (3320), which may have been selected as described above with reference to FIG. 3A (3040). The processor 402 then analyses the images to identify an approximate location of the umbilicus in the remaining images. The processor 402 may be configured to do this by applying a deep learning algorithm such as a neural network or a residual network, for example a R-CNN, for example Faster R-CNN with ResNet, as described at He, K., Zhang, X., Ren, S. and Sun, J., 2015. Deep Residual Learning for Image Recognition. [online] arXiv.org. Available at: <https://arxiv.org/abs/1512.03385> [Accessed 2 Jul. 2021]; and Ren, S., He, K., Girshick, R. and Sun, J., 2016. Faster R-CNN: Towards Real-Time Object Detection with Region Proposal Networks. [online] arXiv.org. Available at: <https://arxiv.org/abs/1506.01497> [Accessed 2 Jul. 2021]. Umbilicus detection may be based on texture analysis, for example based on texture lines. Other methods of umbilicus detection may also be used, for example, clustering techniques.

The processor 402 then defines a second circle in 3D space—e.g. by calculating a set of 3D coordinates. This circle corresponds to the rotation of the umbilicus about the pose registration axis based on the location of the umbilicus identified in the set of images. Based on the angular position for each image calculated above in relation to FIG. 3A, the processor 402 thus generates an association between a set of angles, and a corresponding set of projected coordinates. These projected positions corresponding to the expected position of the umbilicus (3340) when the subject is standing in the relevant angular position. For the angularly adjacent images, the processor 402 estimates the location of the umbilicus based on its position in the front view image and the angle between that image and the front view image. This may be done by assuming that the umbilicus moves through an elliptical path, corresponding to the second circular path viewed with respect to the position of the camera, as the subject rotates. The position of the umbilicus is tracked using the elliptical path to estimate the position/height of the umbilicus in the side view image, as determined by the radius of rotation of the umbilicus, for example as shown in more detail with reference to FIG. 4C.

The estimated umbilicus positions may then be stabilised (3360) by following a method similar to that described above with reference to FIG. 3B for the shoulder joints. In particular, the processor 402 analyses the image Fₙ in which the location of the umbilicus is to be stabilised to identify features, such as texture based features in that image and corresponding features in another image in which the location of the umbilicus has already been estimated. Other feature extraction analysis methods may be used to identify the umbilicus, for example clustering, or a combination of texture analysis and clustering. The image in which the location of the umbilicus has already been estimated is then also analysed to identify the same (or corresponding) features. By determining the mapping between the features of image Fₙ and the image Fₙ₋₁ an association between the two images, such as a spatial transform, is determined by the processor. The processor 402 then applies this association to the image in which the location of the umbilicus is known to predict the location of the umbilicus in the image to be stabilised. The predicted location and any prior estimate of the location can then be combined to estimate the umbilicus location for that image (3400).

The location of the umbilicus, and the angular data describing the images (see above) is used to determine the location in 3D space of certain landmarks of the human skeleton such as the junction between the 3^{rd} and 4^{th} vertebrae.

The location of the shoulder joints may then be used together with the locations of the umbilicus to identify to provide a mapping between the model of standard human anatomy and the images of the subject, and/or provide the position of the subject's bandline.

FIG. 3D provides a schematic illustration of a method of identifying anatomical features of the subject/user's body, and will now be described in more detail below.

The processor 402 determines the vertical height of the junction between the 3^{rd} and 4^{th} vertebrae by the vertical height of the umbilicus as identified in the front image, described with reference to FIG. 3C. This is based on the anthropometric relationship wherein the height of the umbilicus corresponds to the height of the junction between the 3^{rd} and 4^{th} vertebrae. The processor 402 then determines the location of the junction of the 3^{rd} and 4^{th} vertebrae in 3D space (3420) based on the radius of the second circle of rotation, generated with reference to FIG. 3C, such that the location of the vertebrae junction is defined by the point of intersection between the vertical height of the umbilicus with the axis of rotation, as shown in more detail with respect to FIG. 4C.

A model of standard human anatomy is then obtained by the processor 402 (3440), wherein the model comprises a set of anatomical markers corresponding to the location in 3D space of a set of anatomical landmarks. The set of anatomical markers may comprise vertex and edge information, wherein vertices comprise spatial coordinates and edges comprise an association between the vertices. The marked model of standard human anatomy may be stored in the memory. In this example, the model of standard human anatomy is a marked model of a standard human skeleton, however other models may be used. The set of anatomical markers in this example comprises at least the location of the shoulder joints, the junction between the 3^{rd} and 4^{th} vertebrae, and at least a portion of the ribs, for example the 2^{nd}, 4^{th}, and 8^{th} rib pairs. However, in other examples, additional anatomical markers may also be used, including but not limited to all rib pairs, sternal notch and xiphoid process, spinal cord, vertebral disc, intervertebral disc and thoracic vertebrae.

The processor 402 determines a spatial transform (3460) to transform the set of anatomical markers of the model of standard human anatomy such that the relative locations of the anatomical markers in 3D space representing the shoulder joints and the junction between the 3^{rd} and 4^{th} vertebrae coincide with the relative locations of the shoulder joints and the junction between the 3^{rd} and 4^{th} vertebrae of the subject determined from the set of 2D images. This establishes the interrelation of the shoulder joints of the subject and the junction between the 3^{rd} and 4^{th} vertebrae in 3D space associated with the model. This may be done using projective geometry, for example by matching the model of standard human anatomy to the angular position for each image and projecting the relative 3D positions of the anatomical markers from the 3D marked model onto each 2D image of the subject based on the relative locations the shoulder joints and the junction between the 3^{rd} and 4^{th} vertebrae. The spatial transform may be a projective transformation wherein the relative locations of the anatomical markers are invariant relative to each other (i.e. the relative locations of the shoulder joints and the junction between the 3^{rd} and 4^{th} vertebrae form a triangle of fixed shape). This results in a marked set of images of the user comprising the anatomical markers. The registered anatomical markers are output as spatial coordinates. These may in turn be used to identify morphological parameters of the user's breast including, but not limited to, bandline location breast root location at that pose, and gaps between breast root at different vertical positions.

The processor 402 then locates the bandline zone (3480) of the user based on the relative locations of the anatomical markers in the images. The bandline zone is identified by the processor 402 as the region between the anatomical markers for the 4^{th} and 8^{th} ribs. The processor 402 may then identify the bandline location based on the bandline zone, for example based on stored data defining bandline location according to a characteristic of the subject-such as the subject's age, width, height, breast curvature, and breast heaviness. In this example, the subject characteristics used to determine bandline are obtained from a subject questionnaire, for example wherein the subject manually inputs at least one of breast heaviness, breast curvature, age, width, height. In some examples, bandline location is determined using a machine learning approach based on at least one characteristic of the subject, for example as mentioned above.

Where the umbilicus cannot be identified (e.g. obscured by clothing), any or any combination of: the shoulder joints; the ankle joints; and/or the hip-leg joints may be used to identify the location of the subject's bandline in the images. This may be achieved using a machine learning approach, for example based on the known shoulder length from the front view and breast curvature extracted from the side view image (for example, as discussed in more detail in relation to FIG. 5). The subject's bandline measurement can then be determined based on the front view image and/or the side view image and the bandline location without identifying the umbilicus.

The processor 402 then determined the breast root height (3500) based on the location of the anatomical marker for the 2^{nd} rib and the bandline location. Other methods for determining the breast root height may be used, for example based on identifying points of inflection corresponding to the breast root from extracted edge information as discussed in more detail in relation to FIG. 5.

An image of the subject from a top view (which in this example is provided by the user but in other examples can be generated from the images of the user) is also obtained by the processor 402 (3520). The processor 402 performs image segmentation, first to segment the body of the subject from the background, and then to segment the body of the subject into anatomical regions, including segmenting each breast from the torso. Segmentation of body parts of the subject is based on a deep learning approach, for example based on contour analysis. However, other body part image segmentation techniques may be used, for example template-based approaches.

The torso of the subject from the top view, comprising the breast, is constrained by a rectangle in the horizontal plane (see the rectangles indicated in FIGS. 8B and 8C). The processor 402 then scales the top view image to match the first set of images (3540) by determining the size of the rectangle based on at least one of the width of the torso as determined by the width of the torso in the front view image, or the depth of the torso as determined by the depth of the torso in the side view image.

The processor 402 then extracts edge information from the top view (3560). Edge information is extracted as an 8-connected contour for each image and stored as a chain code data structure, for example as discussed in more detail in relation to FIG. 5. However, the skilled person will understand that other edge extraction methods can be used.

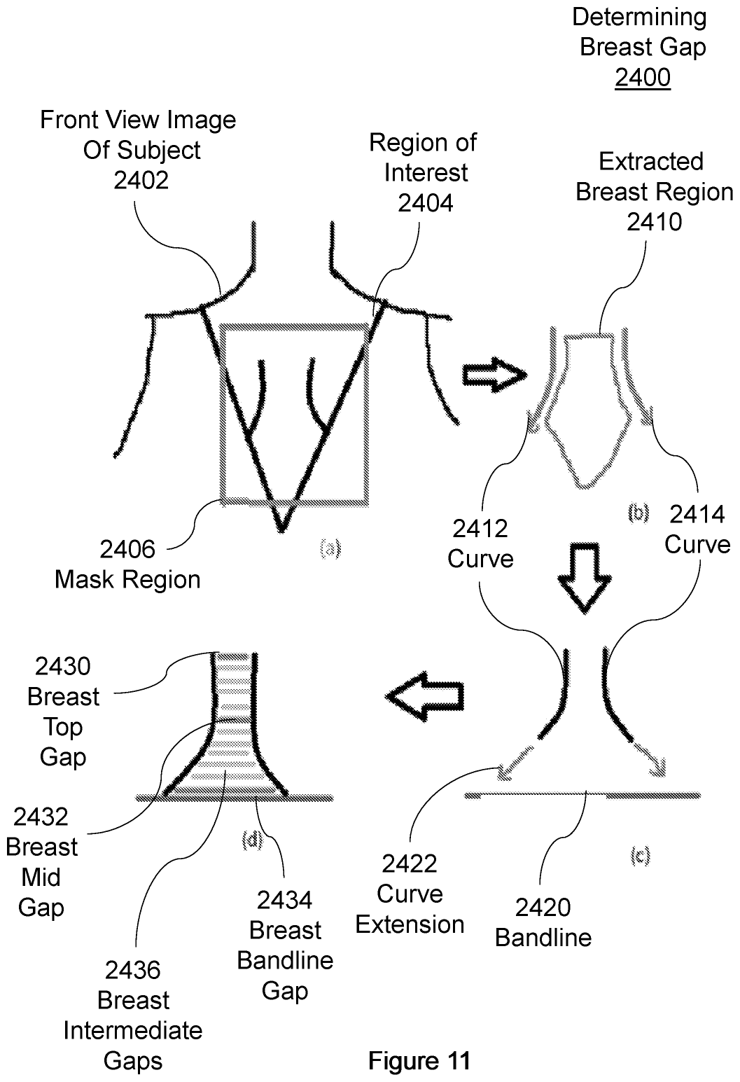

The processor 402 then analyses the segmented top view image, including the extracted edge information, to determine at least breast orientation relative to the projection plane, breast root width, and breast separation (3580). Breast orientation is determined relative to any plane parallel to the projection plane, for example as discussed in more detail in relation to FIG. 10G. Breast root width may be defined as the distance between the start and end of the breast, as viewed from the top view. Breast width may be calculated using curvature analysis, for example identifying point of inflection as described in more detail in relation to FIG. 5, to determine the start and end of each breast root and extrapolating the breast root width between these points. In other examples, the start and end points of the breast root may be determined using ML-based or template-based approaches. Breast separation may be defined as the distance between the two breast roots, as described in more detail in relation to FIG. 10D. Further details for calculating breast separation (or “breast gap”) are provided below in the description pertaining to FIG. 11.

FIG. 3E provides a schematic illustration of a method of generating a 3D model of the subject, which will now be described in more detail below.

First, the processor 402 obtains a 3D model of standard human anatomy, corresponding to at least a human torso (3600). In this example, the model is a mesh model.

The processor 402 then marks the position of each breast root on the model (3620). The breast root position is marked parallel to the projection plane. The breast root position is aligned with the plane of the sternum, wherein the position of the sternum is identified using anatomical markers. The position of each breast root is marked by a constraining rectangle. The height of the rectangle is determined by the breast root height previously determined; the width of the rectangle is determined by the breast root width previously determined. The position of the breast root rectangle is determined by the relative location of the breast root width and the breast root separation, as determined from the top view image. A breast root shape is then fit within the constraining breast root rectangle, wherein the shape is based on a standard breast root shape determined by a model of standard human anatomy. The breast root is then projected to be wrapped onto the torso model using ray-tracing and spring-damper method. This gives a three-dimensional surface of breast root overlapping on the torso model.

In other embodiments, instead of a static elliptical breast root shape the average of multiple three-dimensional scans and information derived from a medical model is used as the breast root shape that is fit within the constraining breast root rectangle.

The processor then extracts edge information of the subject's body, including the breast, from the side view image (3640). Edge information is extracted as an 8-connected contour for each image and stored as a chain code data structure, for example as discussed in more detail in relation to FIG. 5. However, the skilled person will understand that other edge extraction methods can be used.

The processor 402 then marks n spaced parallel lines between the mid-point of the shoulder joints and the position of the umbilicus in at least the side view image of the subject and a 3D model of standard human anatomy (3660). The n parallel lines are orthogonal to the pose registration axis. The n parallel lines may be spaced via any function, for example linear, logarithmic, or exponential.

The processor 402 then scales the 3D model to the subject. his scaling is achieved by applying a spatial transformation to the 3D model to transform the n lines of the 3D model to coincide with the n lines of the subject in the side view image.

In an alternative example, this scaling is achieved by stretching the model in the vertical direction/plane such that it meets the length requirement. Then, obtaining torso slices at n vertical positions, scaling is applied to each slice in the horizontal and depth dimensions/planes to match with the user's dimensions at each of the n layers. The depth dimension is obtained from a substantially side-view image and the horizontal dimension is obtained from the substantially front-view image. The frontal part of the layer is further parameterised and the slices are deformed based on these parameters, whereby a bounding box is scaled for each of the n slices and the torso boundary within the bounding box is parameterised while keeping the bounding box dimension standard such that the parameters are adjusted to match the subject's torso. The parameters are obtained using a machine-learned model which is trained on real user data. These n layers of two-dimensional slices are then positioned, connected to neighbouring slices and the connecting topography smoothed across multiple layers to provide the final three-dimensional torso model.

The model is additionally scaled using size information, determined above using the focal length of the camera, or otherwise, for example using a reference object of known size, as described in more detail in relation to FIGS. 8B and 8C. In some examples, size information may be derived from a combination of extracted camera information and the use of a reference object.

The processor 402 then identifies height and depth spatial data points (y- and z-coordinates) (3680) characterising the subject's body by identifying the intersection point of the contour edge of the subject breast with each of the n lines. In this example, a point located on the centre of the collar bone of the breast is calibrated as the origin (y=0, z=0). In other examples, the origin can be located in another position and/or can be a rigid variable or relative variable.

To characterise breasts of the subject, the processor 402 marks m parallel lines for each of the breasts in the top view image and the 3D model (3700), wherein the m parallel lines are orthogonal to the breast orientation, for example as shown in more detail in relation to FIG. 6A. The m parallel lines may be spaced via any function, for example linear, logarithmic, or exponential.

The processor 402 then identifies width and depth spatial data points (x- and z-coordinates) characterising each of the subject's breasts by identifying the intersection point of the contour edge of the user breast with each of the m lines (3720). The highest point of the breast is calibrated as the origin (x=0, z=0).

Using the common origin and z-axis, the processor 402 determines the 3D spatial correlation for all spatial data points. The relative three-dimensional spatial correlation of the two-dimensional points in each image may be determined using a point cloud projection. Other methods of determining the relative three-dimensional spatial correlation of two-dimensional points may also be used, for example using point triangulation. The spatial data points are then co-registered into a 3D spatial coordinate system (3740). These 3D spatial coordinates may be referred to as 3D control points. An example method of co-registration is shown in more detail in FIG. 6B.

In this example, the processor 402 is then able to deform the 3D model using a spatial transform such that such that the relative position of the contour points intersecting the n and m lines of the model coincide/align with the position of the corresponding 3D control points (3760). The spatial transform is a non-rigid transform, such as a moving regularised least square error minimisation algorithm. However, other non-rigid spatial transforms can be used. Other deformation methods may also be used such that the deformed model resembles the shape of the breasts of the subject, for example by projecting orthogonal oval slices parallel to each other to form the breast, wherein the locus of the centre of these ovals provides breast orientation and shape, and deforming the model to coincide the projected orthogonal oval slices of the model to align with those of the user.

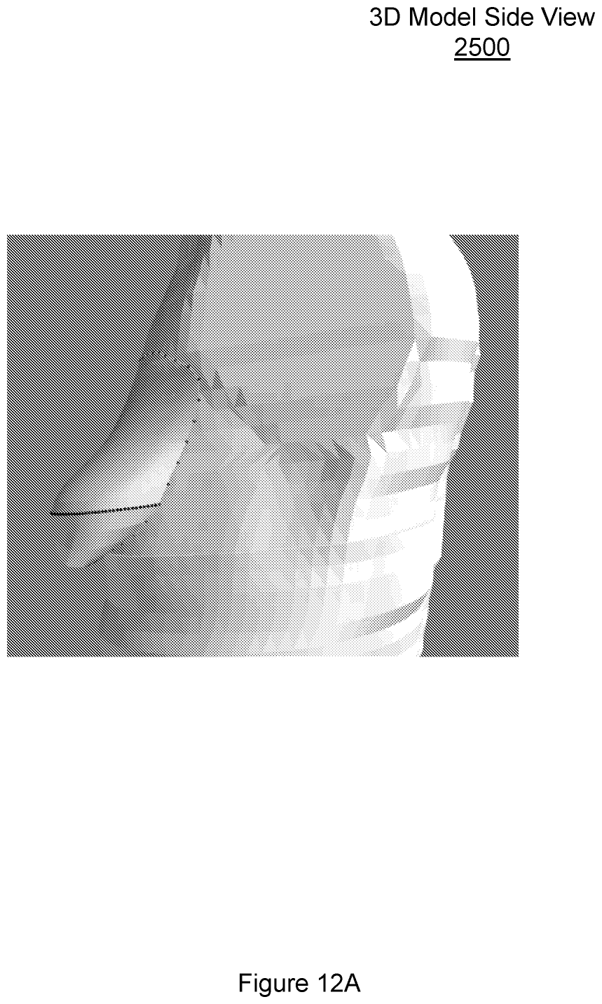

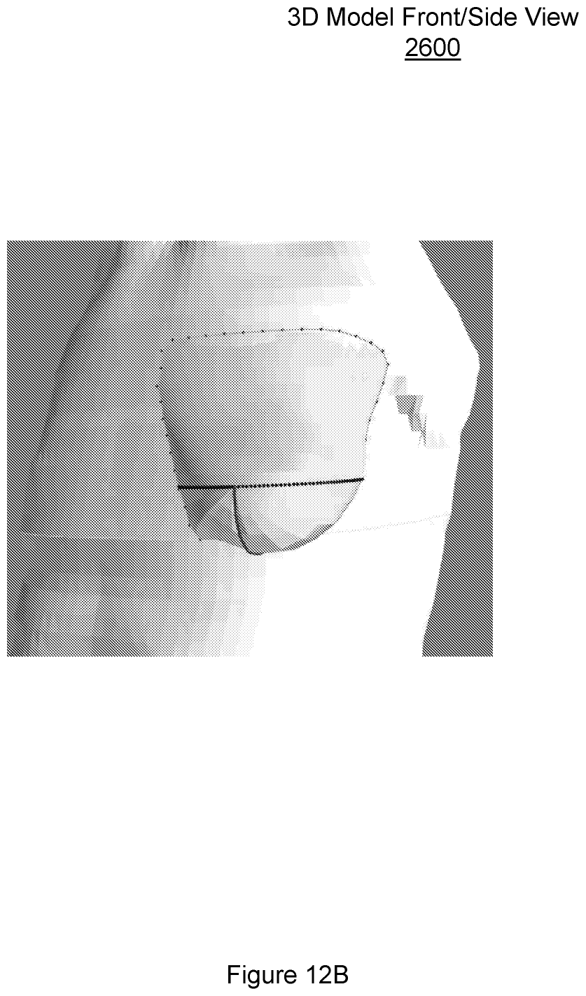

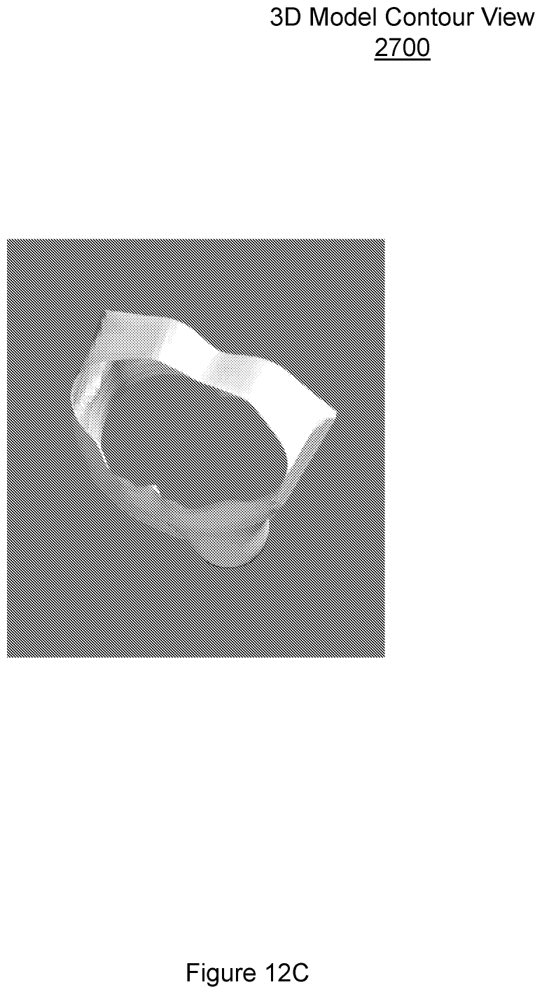

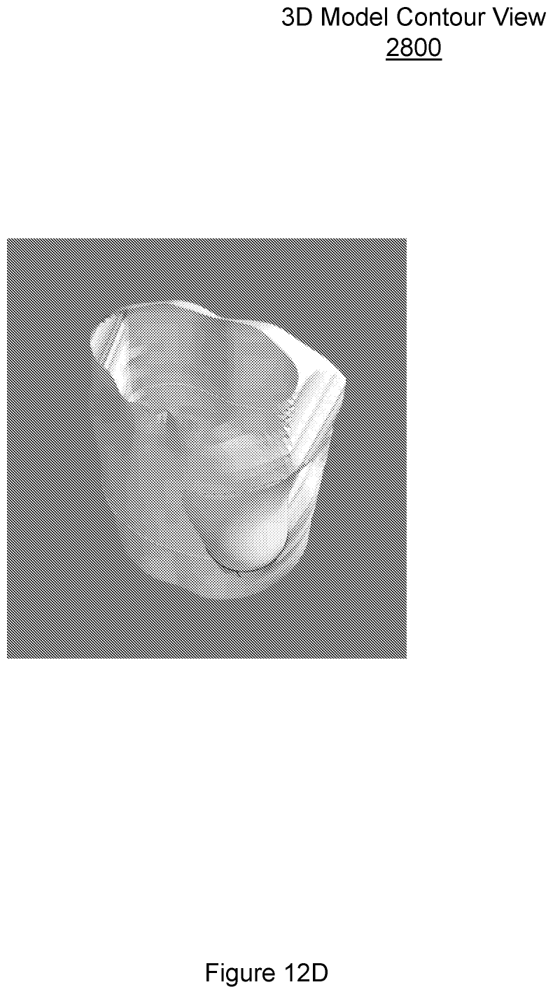

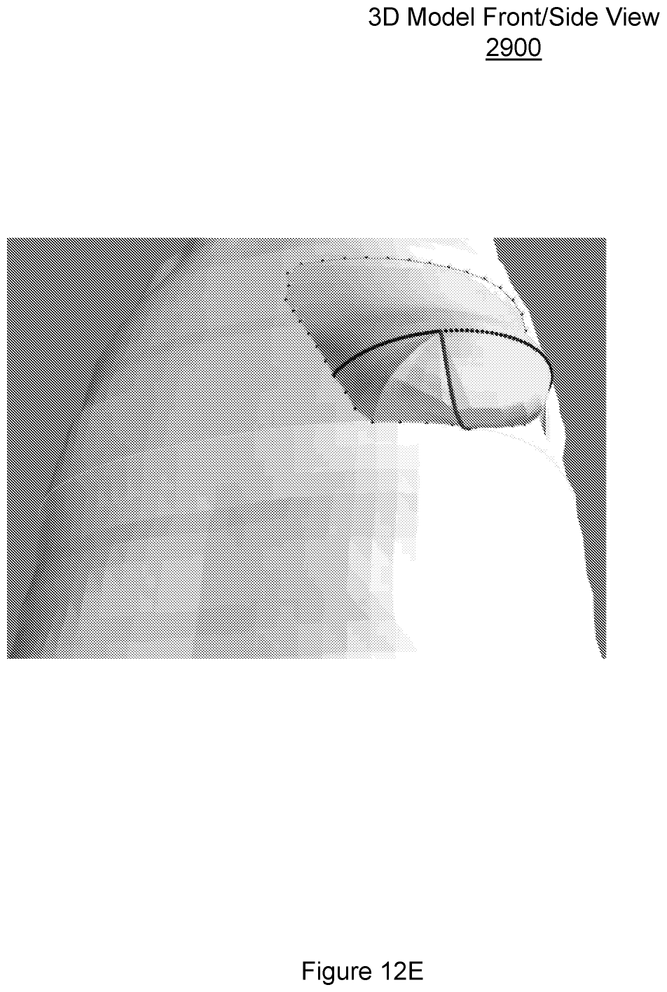

In an alternative example, shown in FIGS. 12A to 12E, the user's breast spillage, breast gap (obtained from the front view) and breast highest point (obtained from the side view) are used to identify the orientation of the breast where the frontal projection (X-Y plane) vector is obtained by joining the midpoints of breast root start line (where 2^{nd} rib is located) and the function of spillage and breast root at breast-highest point Y-position in the front view. For the Y-Z plane this is the vector joining 2^{nd} rib projection point and highest point. The side view contour is then placed on that 3D vector and, for each Y, a spline is generated using a parametric geometrical method where parameters are obtained from the ML model. Each spline in 3D space is then connected to their neighbour to generate 3D mesh and a 3D model of breast is obtained.

The processor 402 may then perform smoothing and noise removal to the deformed model for increasing the convexity post the non-rigid transform. In some examples, the model is perturbed with the objective of making the breasts of the model achieve the convexity of half a tear-drop shape.

The processor 402 then calculates the breast volume of the model (3780) based on the volume constrained between the plane of the breast root and the outer surface which defines the breast.

In some examples, the method terminates at this stage. Other example morphological parameters of the breast may also be calculated from the 3D model of the user, for example at least one of breast shape (for example tear-drop, full-on-top, heavy-on bottom, dripping etc.), breast root topography, breast orientation, breast separation, presence of side breast, side breast volume, side breast area, breast tissue distribution, breast 3D control points, bandline length, bandline location, breast-garment association, garment size, breast root location, breast root height and/or width, breast tissue strength. Example morphological parameters are discussed in more detail below, in relation to FIGS. 10A to 10I.

In other examples, the method proceeds in relation to FIG. 3F which will now be described in more detail below.

FIG. 3F provides a schematic illustration of a method of adjusting a 3D virtual garment to the 3D model of the user. In this example, the processor 402 obtains a virtual garment, comprising garment markers. The virtual garment may be stored in the memory. In this example, the virtual garment is a virtual bra, however the skilled person will understand that other virtual garments can be used. An example virtual bra 300 is shown in FIG. 3G.

The virtual bra is then applied to the 3D model (3800) by applying a non-rigid spatial transformation such that the position of at least a set of garment markers coincide with corresponding markers on the model, for example the garment marker indicating the bandline of the virtual bra may be transformed to align with the identified bandline location on the 3D model of the user. The corresponding garment fitting markers may be marked on the 3D model of the subject during transformation of the anatomical markers (3460), for example as described above in relation to FIG. 3D.

The processor 402 also deforms the breast of the 3D model (3820) by applying a virtual bra to align with the shape of the virtual bra. The breast is deformed to fit to the virtual bra by preserving the breast volume and surface area. Volume and surface area of the mesh are computed using the triangulation and tetrahedron approach, however other methods may be used.

The processor 402 then readjusts the relative placement of the garment markers on the 3D model of the user (3840). Adjustment of the garment markers is at least based on the bandline and the breast volume of the 3D model. The garment markers correspond to the end points of the seam line of a bra, and/or curves of the bra such as the underwire. Therefore, adjusting garment markers corresponds to adjusting the seam lengths of a real garment.

The virtual bra 300 shown in FIG. 3G comprises seam lines A to Z. In some examples, wherein adjustment is based on at least the bandline and the breast volume, at least a first seam is adjusted according to the bandline length (for example, but not limited to, at least one of Y, T, S, Q, and R), and a second seam is adjusted based on the breast volume (for example, but not limited to, at least one of J, E, G, F, H, A, I, D, K, C, B, and M). The processor 402 then determines a parameter of a real bra, for example size or seam lengths, based on the adjusted garment markers of the virtual bra.

The processor 402 may also determine a parameter of a real bra (3860), for example size or seam lengths, based on a parameter of the breast of the 3D model of the user, for example cup size of the bra may be determined by breast volume. In some examples, the fit of a real bra may be determined by comparing the seam lengths and/or the relative positioning of the garment markers of the virtual garment to known seam lengths and/or the relative positioning of garment markers for a real bra. The fit of the real bra is determined by the similarity of the garment marker measurements of the virtual bra to those of a real garment, wherein more similar measurements correspond to a better fit.

In some examples, the output bra size may be dependent on the product sizing provided by the manufacturer. For example, the size/seam lengths of the virtual bra is/are matched to existing manufacturing parameters of real bras and the relevant product size is determined and output for said manufacturer.

In some examples, considerations of breast tissue distribution and breast tissue strength are used by the processor 402 when deforming the breast of the 3D model to fit the virtual bra.

Morphological parameters may be determined directly from measuring a parameter of the three-dimensional model, and/or based on the adjusted virtual garment.

In the example described above in relation to FIG. 3A, pose estimation comprises sampling the marked model at 1° increments, however it will be appreciated by the skilled person having read the present disclosure that other increments of sampling the marked model may be used.

FIG. 4A shows an example method for extracting pose information of the user based on a plurality of images of the user 100A, for example as discussed in relation to FIG. 3A below in more detail.

In the example shown, the obtained plurality of images of the user 100A represent the user from different views, for example a left tilt 102A, a front view 104A, and a right tilt 106A. Representations of the top view cross sections 100B associated with each view of the user 100A are shown below. In this example, the position of the shoulder joints 108 are identified from the plurality of images and marked in each position. In some examples, identification of the shoulder joints 108 is performed using machine learning based methods, such as deep learning. In other examples, contour- or template-based approaches may be used. The user's pose is then estimated by analysing the relative positioning of each shoulder joint.

In one example, the front pose image 104A is identified from the plurality of images by extracting the distance between the shoulder joints 108 of the user in each of the plurality of images 100A, where the front pose image 104A is identified as the image where the distance between shoulder joints 108 is greatest.

In another example, a line 110 can be extrapolated between the shoulder joints 108 in each position. The front pose image 104A may be identified by extracting the angle formed by the line joining shoulder joints 110 and the projection plane 112, in this case the front pose image 104A is identified as the image where the angle between the lines 110 and 112 is zero.

The degree of rotation of the subject 100 in the plurality of images may also be determined by defining a circular path 120 of the shoulder joints 108 about the axis of rotation 118, as shown in FIG. 4B, wherein the axis of rotation 118 passes through the midpoint 114 between the shoulder joints 108. The sample of the marked standard human anatomy with the matching relative positioning of the shoulder joints as the subject in the image is then identified, wherein the marked model is sampled at 1° increments along the circular path, rotated on its axis of rotation 118, for example the pose registration axis or the vertical axis formed by the intersection of sagittal and frontal planes of the human body. Thus, the degree of rotation of the subject's pose is identified relative to the position of the camera.

In the examples described above in relation to FIGS. 4A and B, the pose is estimated in relation to the relative positioning of the shoulder joints; however the skilled person would understand this method may be performed by analysing the relative positioning of any anatomical markers.

FIG. 4C illustrates a method of identifying the position of the umbilicus 122. The umbilicus is first identified from the front view, for example using a machine learning approach based on texture analysis, however other methods of identification may be used. A circle of rotation 124 is determined about the axis of rotation 118, based on the position of the umbilicus in the set of images. The position/height of the umbilicus 122 in the side view image is then extrapolated using the circle of rotation 124. The position of the umbilicus provides the radius 128 of the circle of rotation 124 relative to the axis 118. The location of the junction between the 3^{rd} and 4^{th} lumbar vertebrae 126 in the side view image can then be extrapolated based on the vertical height of the umbilicus 122 and the radius of rotation 128, i.e. where the vertical height of the umbilicus 122 intersects the axis of rotation 118.

FIG. 5 shows example edge information of a subject's breast 202 extracted from an image of the subject, for example as an 8-connected contour for each image and stored as a chain code data structure. An example method 200 for estimating curvature of the subject's body is shown, using the extracted edge information 202. The edge information 202 is analysed to identify extrema points or points of inflection. These points may then be used in the characterisation of morphological parameters, for example, but not limited to, the shape of the breast, breast orientation, and/or lower breast root.

In the example shown, the edge of interest in the image 202 is traversed by a forward-march technique. A pre-determined window size fixes the number of pixels traversed along the edge, for example in the figure shown, a to x1 marks one march-forward and x1 to b marks the second, where x1 is the point of interest. In this example, the angle across each window is measured and all points of inflection where angle is higher than the threshold θₘₐₓ, or smaller than the θₘᵢₙ, are stored as a data structure as a representation of points on the curves where significant variations occur. Identified points of inflection may then be used during deformation to generate a three-dimensional model of the subject's body, such that the three-dimensional model of the subject's body is characterised by the same measurements at the identified points of inflection. Identified points of inflection can also be used to signify areas of interest, for example a point of interest where the angle is smaller than θₘᵢₙ 206 may signify the breast root, and a point of interest where the angle is greater than θₘₐₓ 204 may signify the point of highest curvature of the breast. In some examples, the point of highest curvature 204 is a candidate for nipple location on the model.

FIG. 6A shows an example method for generating a set of 3D control points, for example as described above in reference to FIG. 3E. In this example, extracted edge information 202 illustrates a segmented part of the top view image, showing one of the subject's breasts. Points 208 are identified to signify the breast root width, indicating the start and end of the breast. These points 208 may be determined using curvature analysis, for example such as the point of inflection approach described above in relation to FIG. 5. The plane of the breast root 210 is extrapolated between the points 208 indicating the start and end of the breast width. The plane of the breast root 210 is perpendicular to breast orientation. A series of parallel m lines 212 are marked across the breast, parallel to the plane of the breast root 210, orthogonal to breast orientation. In this example, the m lines are linearly spaced, however the m lines may be spaced via any function, for example logarithmic, or exponential. Where the lines 212 intersect with the contour edge information 202, a 2D key point is identified.

In some examples, the lines 212 may form projected oval slices 214 through the breast, parallel to the y-axis. Each parallel slice 214 intersects with the contour edge information 202 to form a series of parallel ovals, wherein the perimeter of the oval is constrained by the intersection with the contour edge information 202. The locus of the centre of these ovals provides breast orientation and shape. In an alternative embodiment to the use of 3D control points, the ovals may then be used to deform the 3D model to coincide the projected orthogonal oval slices of the model to align with those of the subject.

FIG. 6B shows an example set of 3D control points 302 that are identified and extracted from at least two 2D images and used to characterise the subject's breasts in three-dimensions, for example for 3D deformation, which will now be described in more detail below.

In this example, two-dimensional key points of the breast are identified from the extracted edge information 202 of the breast, for example as described in reference to FIGS. 6A and 3E, in at least two images of the subject. The three-dimensional spatial correlation of the two-dimensional points in each image is determined by registering at least two images of the subject from different views, for example 300A and 300B, in a one three-dimensional coordinate system 304. In the example shown, the views of the subject may be registered in a 3D cartesian system where the x-axis relates to width, y-axis to height, and z-axis to the depth of the subject's body. This is achieved by identifying corresponding two-dimensional points in the at least two images and finding their three-dimensional spatial correlation, for example using the projection of point clouds or point triangulation methods. The degree of rotation of the subject in the at least two images may be used for point triangulation, wherein the degree of rotation of the subject in the at least two images is determined by pose estimation described above. In this example, the origin is set as the highest point of the breast. The set of 3D points 302 in the coordinate system 304 that represent the breast shape are called 3D breast control points. The 3D breast control points may then be used for 3D deformation to generate a three-dimensional model of the subject, for example by deforming a model of the standard human anatomy by mapping anatomical markers of the model of standard human anatomy associated with the position of the 3D breast control points onto the set of 3D breast control points extracted from the images of the subject, such that the breasts of the deformed model resemble the shape of the breasts of the subject. The model is deformed to coincide/align the corresponding 3D breast control points via a non-rigid transformation, for example a moving regularised least square error minimisation algorithm where control points are aligned most optimally.

FIG. 7 shows an example image 500 of a subject 502 in a pre-determined pose, for example the at least one image of the subject obtained in any of the methods described above, which will now be described in further detail below.

In this example, the predetermined pose comprises a neutral spine and abduction of the arms at the shoulder, with the upper arms extended laterally in the coronal plane and substantially parallel to the ground. In this example, the subject's hands/fingers are touching each side of the head, for example approximately around the ear. This predetermined pose is advantageous as the subject's upper torso remains straight in a natural way, without any forward or backward stretching. It also maintains the spine in its natural state and helps keep the head facing straight. This pose may be beneficial as the subject's breasts and/or chest hold their natural shape and orientation which may be beneficial for accurate determination of morphological parameters, for example measurement. Furthermore, this pose avoids occlusion in the upper torso region, enabling key features and visual cues remain visible. These features may be advantageous for computer vision, for easy identification of the subject and subject pose. This may also increase the accuracy of the extraction of features of the subject's body.

In some examples, at least a portion of a plurality of images of the subject are obtained in a predetermined pose, such as the pose shown in FIG. 7, wherein the plurality of images may comprise different views of the subject in the pre-determined pose. Example views of the subject in the predetermined pose may include, but are not limited to: front view; 45 degrees to the right hand side; 90 degrees to the right hand side; 45 degrees to the left hand side; 90 degrees to the left hand side. In some examples, a plurality of images of the subject in a pre-determined pose may be obtained whilst the subject rotates.

FIG. 8A shows two example images 500A and 500B comprising the subject 502 and a reference object 602, for example at least two images of a plurality of images of the subject obtained in any of the methods described above, and these example images 500A and 500B will now be described in more detail below.

In this example, the reference object 602 is a standard debit-card sized object according to ISO\IEC 7810 #ID-1, however other reference objects of known dimensions may be used. In this example, the reference object 602 is identified within the images 500A and 500B using a line-based card detection algorithm, for example using a Hough transform. In some examples, the reference object 602 may additionally have a standard colour to facilitate identification of the reference object 602 using colour-based object detection, for example the reference object 602 may be a green card of standard ISO\IEC 7810 #IP-1 in GREEN colour.

In the example shown, the second image 500B depicts the reference object 602 in a second position relative to the subject 502, the second position being different from the first position of the reference object 602 depicted in the first image 500A. In some examples, the positions of the reference object 602 relative to the subject 502 within a plurality of images 500 are determined according to a set of predetermined poses of the subject 502, comprising predetermined positions of the reference object 602. In the example shown, the second image 500B also depicts the subject 502 from a different view, however the skilled person would understand that the second image may comprise the subject 502 in the same view, wherein only the position of the reference object 602 relative to the subject 502 is changed.

A reference object 602 of known dimensions can be used for the conversion of pixel measurements of the images, for example images 500A and 500B, into real world dimensions, for example by determining the pixel:cm scaling ratio in the plane of the reference object 602. A dimension of the object 602 in an image is measured in pixels, as the real dimension of the object 602 is known, the scaling ratio in the plane of the reference object 602 can be calculated.

The scaling ratio is then determined from the plurality of images for a plurality of different planes of the subject's body to determine the per pixel scaling contribution of the reference object 602. The per pixel scaling contribution refers to the weight of pixel in a plane and its unit is pixel: metric. The projection length of the reference object 602 at various positions on the subject's body 502 determines the per pixel scaling contribution of the reference object 602, wherein the reference object 602 is positioned on different planes relative to the subject's body 502. The per pixel scaling contribution metric helps in determining the contribution of card pixels to real world measurements when located at different planes within the images 500A and 500B. The per pixel scaling contribution is used to establish quantitative measurements, for example in centimetres or any other metric scale, of the height, width, and depth of the subject's body 502. In some examples, the dimensions are specifically focused on the upper torso region of the subject's body 502.

An example method of scaling is shown in FIG. 8B which comprises obtaining scaling information from at least two images comprising at least two different positions 600A and 600B of the reference object 602, and which will now be described in more detail below.

In this example, the first position 600A corresponds with the example image 500A in FIG. 8A, and the second position 600B corresponds with the example image 500B in FIG. 8A. A bounding rectangle 604 is shown to encompass a cross-sectional view of the subject's body 502. In this example, the bounding rectangle 604 represents the cross-section of the subject's body 502 at the highest point of the breast. The example position of the reference object 602 shown in image 500A provides the pixel to the real-world measurement conversion (e.g. pixel:cm ratio) from the plane aligned with the highest point on the breast, as shown in 600A. The length 606 of the bounding box 604 around the highest points of the breasts is determined as a length in pixels and converted it to real-world measurements using the known dimensions of the card. Similarly, the example position of the reference object 602 shown in image 500B provides the pixel to real world measurement conversion for the width 608 of the bounding box 604, as shown 600B. Real world measurements of other values from the same plane as the reference object 602 may also be calculated, such as the rise of breast from the torso 610 as shown in 600C, as well as other values from the same plane as the reference object 602 but at a different cross-sectional height, such as distance 612 of umbilicus 614 from the axis of rotation 616 as shown in 600D, wherein the bounding rectangle 604 is shown to encompass a cross-sectional view of the subject's body 502 at the height of the umbilicus 614.

In other examples, placing the reference object 602 at the sternum, for example on the collar bone in the middle of the shoulders, can provide pixel to real world measurement scaling information for multiple parameters sharing the same plane in the image as the sternum and/or torso. These parameters may include at least one of the bandline bounding box length, width of the torso, height of the torso, breast separation, and distance between shoulder joints.

Upon finding the pixel length of the reference object 602, for example as described above in relation to FIG. 8B, these lengths are then used to find the pixel: cm conversion for the respective planes, as shown in FIG. 8C which will now be described in further detail below.

The per pixel contribution at that plane (i.e. 618 and 620 in FIG. 8C) is established. In the example shown, the length of rise in breast 610 from reference object position 602B will help in determining the rate of change of per pixel contribution as we move from the highest point of breast at object position 602A to the sternum at object reference position 602B. This is may be achieved using the relative sizes of the object at each position. Once this rate of change is calculated, the per pixel contribution of any plane may be found and applied to convert pixel to real world lengths whether or not a card is present in that plane for all X-Y planes. This size information in terms of real world lengths may then be applied to the 3D model of the user.

It will be understood by the skilled person that the relative positions of the reference object 602 included in FIGS. 8A to 8C are for illustrative purposes only, and other positions of a reference object 602 relative to the subject's body may be used.

FIG. 9 outlines a method 4000 for determining a morphological parameter of a subject's body, for example according to any of the methods described above, including in relation FIGS. 3A to F, wherein size information of the subject is determined based on the apparent size of a reference object. FIG. 9 will now be described in more detail below.

This method 4000 may be used to determine size information, either instead of or as well as determining size information using the focal length of the camera. A first two-dimensional image showing a first view of the subject and a reference object in a first position relative to the subject is obtained 4020.

A second two-dimensional image showing a view of the subject and a reference object in a second position relative to the subject is also obtaining (4040), wherein the second position of the reference object is different to the first position, for example such as the example first image 500A and the example second image 500B as shown in FIG. 8A.

The method then determines size information of the subject based on an apparent size of the reference object in the first image and the second image (4060), for examples as discussed above in relation to FIGS. 8B and 8C. The determined size information, for example the per pixel scaling contribution, is used for determining size information of the extracted features of the subject's body.

A three-dimensional model of the subject's body is then generated based on at least the size information (4080).

A morphological parameter of the subject's body is then derived from the three-dimensional model of the subject's body (4100), for example as described in any of the methods above.

In some examples, the size information comprises size information corresponding to at least two different planes of a three-dimensional space. In some examples, generating the three-dimensional model comprises applying the size information from the at least two different planes to corresponding planes of the three-dimensional model.

In some examples, additional features are extracted from the plurality of images of the subject as described above, for example edge information, which are additionally used in generating the three-dimensional model (4080) of the three-dimensional model.

In the example method described above, the second image 500B of FIG. 8A also depicts the subject 502 from a different view relative to the first image 500A, however the skilled person would understand the second image may comprise the subject 502 in the same view, wherein only the position of the reference object 602 relative to the subject 502 is changed. The skilled person would also understand that views of the subject as depicted in the first image 500A and second image 500B are intended to be illustrative and not limiting. Example views of the subject may include, but are not limited to, front view, 45 degrees to the right-hand side, 90 degrees to the right-hand side, 45 degrees to the left-hand side, 90 degrees to the left-hand side.

In some examples, the positions of the reference object 602 relative to the subject 502 within a plurality of images 500 are determined according to a set of predetermined poses of the subject 502, comprising predetermined positions of the reference object 602. In some example, the first position and the second position each correspond to different positions of a predetermined set of anatomical locations. In some examples, the predetermined set of anatomical locations each correspond to different planes in a standard three-dimensional model of the human body, for example as discussed above in relation to FIGS. 8A to 8C.

In the example method described above, the reference object 602 is depicted at the highest point of the breast in image 500A and at the ribs in image 500B; however, the skilled person would understand the positions of the reference object 602 discussed above is intended to be illustrative and not limiting. Example positions of the reference object relative to the subject may include, but are not limited to, the sternum, the highest point of at least one breast, collar bone, jugular notch, and ribs.

The apparatus of FIGS. 2A and 2B may be configured to perform the example method of FIG. 9.

Example morphological parameters, such as those determined by any of the methods described above, may include, for example, at least one of breast volume, breast shape (for example tear-drop, full-on-top, heavy-on bottom, dripping etc.), breast root topography, breast orientation, breast separation, presence of side breast, side breast volume, side breast area, breast tissue distribution, breast 3D control points, bandline length, bandline location, breast-garment association, garment size, breast root location, breast root height and/or width, breast tissue strength. The morphological parameters may be determined either directly from the three-dimensional model of the subject or based on adjusted garment markers of a virtual garment.

Bandline location may be defined as the localised torso level where the bandline is usually present, wherein the bandline refers to the bandline of a bra. In some examples, the bandline location is estimated within the bandline zone using an algorithm considering factors such as age, breast heaviness, curvature etc. The bandline zone is identified on the subject's torso between 4th and 8th rib. Identification of the bandline zone of the three-dimensional model of the subject may be determined from the location of an anatomical marker based on the marked model of stand human anatomy. This zone helps in localising bandline with high accuracy. The bandline location may help in fitting the garment, wherein fitting the garment refers to fitting both virtual and/or real garments. Bandline length may be defined as the length of the bandline of the subject, which correlates to the perimeter of a cross-section of the subject's body at the bandline location. In some examples, bandline length may be first approximated in CV using a rectangular measurement obtained from images, as shown in FIG. 8B, and refined in the 3D model. The bandline length may also help in fitting the garment, wherein fitting the garment refers to fitting both virtual and/or real garments.

Breast root topography may be defined by the shape of the breast at the plane describing the root of the breast 800, as shown in FIG. 10A which will now be described in more detail below along with FIG. 10B to FIG. 10I.

Breast root topography may be helpful for determining a bra cup/support element/garment fit type, as well as being useful for prosthetics fitting, and surface fitting of the cup fabric (i.e. how the cup fabric sits on the surface of the breast). Breast root height and width may be defined as the height 802 and width 804 of the breast at the breast root plane 800. These parameters may also be helpful for determining bra cup, support element, garment, and/or prosthetic fit. Prosthetic fit may describe how the prosthetic sits on the plane on which it is supposed to be attached.

Breast shape may be defined as the individual shape assigned to the subject's breast. Breast shape may be determined by at least one of the characteristics: top fullness, bottom fullness, side-frontal fullness, breast separation, underbust crease, chest/ribcage shape, nipple position, shoulder shape, belly shape, spinal curvature, and unevenness of breasts. Breast shape parameters may be helpful to accurately characterise and measure the subject's breast, as well as informing product recommendation for determining good fit of a garment or prosthesis. Regions of the breast are illustrated in FIG. 10B relating to top fullness 806, bottom fullness 808, side-frontal fullness 810. In some examples, top fullness 806, bottom fullness 808, and side-frontal fullness 810 may be categorised as full, semi-full, shallow, or deflated.

Breast separation may be defined as the distance 814 measured between the starting point of the inward root 813 of both the breasts 812, as shown in FIG. 10C. In some examples, breast separation may be categorised as separated 814A (for example, wherein separation is greater than 0 mm), touching (no separation) 814B, splayed 814C (touching, but forming a triangular shape between the breasts), wide-set 814D (separated above a threshold distance, for example more than three fingers distance, wherein more than three fingers distance may be approximated, such as more than 40 mm, for example more than 50 mm), or combinations of the above, for example, wide-set and splayed 814E, as seen in FIG. 10D. Underbust crease may be defined by the width 816 of the lower crease 818, where the breast joins the breast root 800, as shown in FIG. 10E. The measurement of this width 816 helps in determining garment or prosthesis fit, for example the fit of a cup/support element in a garment.

Chest/ribcage shape may be categorised as hollow, semi-hollow, regular, semi-protruding, or protruding. This characterisation describes whether the sternum/breastbone is protruding, hollow or regular relative to the standard position of the sternum, for example as defined by the standard model of human anatomy. Shoulder shape may be characterised as balanced, tapered, or tilted. Belly shape may be characterised as high, or normal. Spinal curvature may be characterised as normal or hunched.

Nipple position may be defined relative to the centre of the breast 820. Nipple position may include which direction the nipple 815 lies with respect to the centre of the breast 820, and/or the distance of nipple 815 from the centre of the breast 820, as shown in FIG. 10F.

Unevenness of the breast may be defined in the difference in the above breast shape parameters between each breast. In some examples, unevenness of the breast may be defined in the difference in cup sizes between each breast, for example a subject's left breast is 2.5 cup sizes larger than the subject's right breast.

Breast volume may be defined as the volume of the breast entity, measured separated entirely from the torso at the breast root. The volume of the breast is obtained from the 3D model of the subject. Keeping breast volume fixed while adjusting virtual garments on the 3D model helps provide an accurate representation of the fit of the breast in a variety of shaped garments.

Breast orientation is the angle towards which the breast is pointed and gives the degree of outward deflection of breasts in the subject. Taking the nipple as the highest point on the breast, the angle 822 of the nipple 815 is measured relative to the Z axis 824 of the X-Y plane 826 containing the sternum, as seen in FIG. 10G. This metric helps in visualising/understanding the garment behaviour on the subject's shape for working with the subject's desired fit.

Breast tissue strength and distribution are determined by segmenting the breast 812 into n sections 828, wherein the nipple 815 is taken as the centre, an example is shown in FIG. 10H where n=6. The area/volume per section defines the tissue distribution. The strength of the tissue is calculated by applying a spring system to these sections and finding the spring constant for each section. The spring force model application to the breast requires a hinge point within the tissue and the spring end on the surface. These parameters help in quantifying the shape of the breasts. These parameters may also be associated with other factors, such as the age of the subject etc., for use in a learning model.

Side breast 830 may be defined as an acute sideward extension of the front-side section of the breast and can extend up to below the arms, for example as shown in FIG. 10I. In some examples, side breast 830 may be characterised by a present (yes) or not present (no) parameter which determines whether a subject has a side breast 830 or not. In some examples, side breast volume and/or area may also be extracted from the 3D model of the subject. This may be advantageous for accurate garment/cup measurement and fitting.

Breast 3D control points may be defined as characteristic points of individual breasts and are extracted, for example as described above in relation to FIG. 6.

Referring now to FIG. 11, more details of an embodiment for determining a breast gap 2400 will now be described below.

In step (a), a front view image 2402 is selected for a subject, where the front view image 2402 is an image of a subject in which the cleavage portion of the torso is visible. Using this image 2402, a region of interest 2404 is selected and a mask region 2406 is applied using a trained Mask Region-Based Convolutional Neural Network.

The Mask Region-Based Convolutional Neural Network is trained on a set of training data of similar images.

The front view image 2402 in some embodiments is selected from a plurality of images as the image that best shows the cleavage portion of the torso, or in other embodiments can be generated from such a plurality of images.

In step (b), the extracted breast region 2410 has two curve portions 2412, 2414 representing the borders of the subject's cleavage within the region of interest 2404 and mask region 2406. The curves of these curve portions 2412, 2414 are extracted and the curve portions 2402, 2414 extended in step (c) using a curve interpolation method.

In step (c), the curves 2412, 2414 are extended 2422 up to the bandline 2420. In the Figure, the poses are registered to be on the same plane for accuracy.

In step (d), the distances between the extended curves 2412, 2414, 2422 are used to identify the length of the breast top gap 2430, the breast mid gap 2432 and the breast bandline gap 2434. Additionally, the intermediate distances between the breast top gap 2430, the breast mid gap 2432 and the breast bandline gap 2434 are also determined and stored to improve the breast gap analysis. The breast intermediate gaps 2436 are also identified in FIG. 11 and are stored to improve the breast gap analysis.

Breast garment association may be defined as a mapping between any virtual garment models and the 3D model of the subject. As described above, mapping between the virtual garment and the 3D model of the subject may be achieved using a marker-based approach.

The term “model” as it is used herein typically means 3D spatial data, such as coordinates and other spatial data used to define a virtual object in 3D space, for example by defining the coordinates of its surface whether as a mesh model or by some other means.

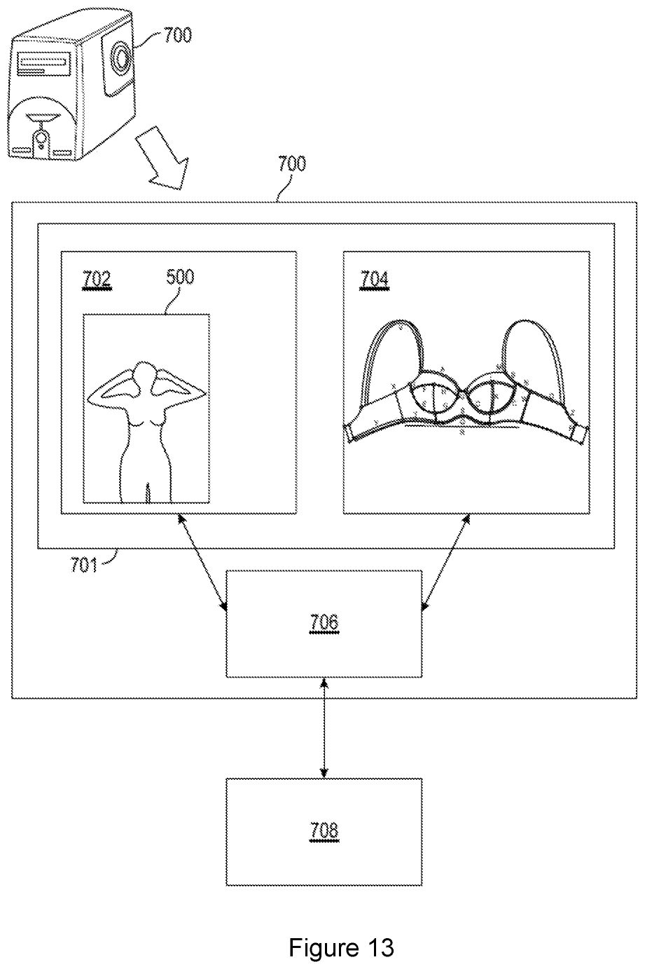

FIG. 13 shows an apparatus 700 for providing a manufactured wearable garment for a human subject. The apparatus 700 comprises a memory 701, comprising an image data store 702 for storing image data and a garment fit data store 704 for storing a plurality of items of garment fit data, wherein each item of garment fit data corresponds to at least one manufacturable garment. The apparatus 700 further comprises a data processor 706. The data processor 706 is arranged to communicate with the garment fit data store 704 and the image data store 702.

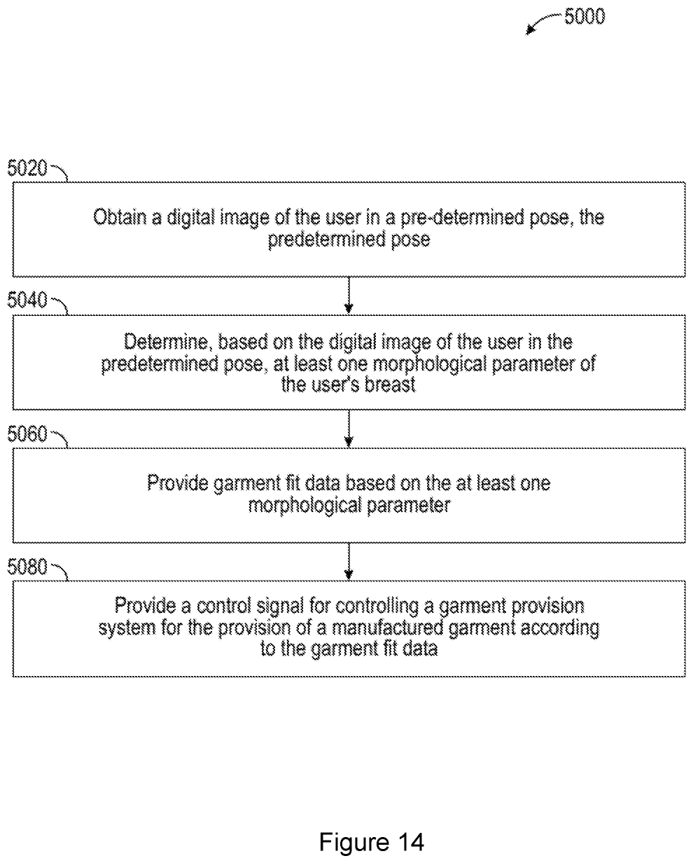

The apparatus 700 is configured to perform a method 5000 such as that described below 20 with reference to FIG. 14. In overview, in this method the data processor 706 obtains, from the image data store 702, a digital image 500 of the subject in a pre-determined pose. The predetermined pose comprises abduction of the arms at the shoulder, for example the predetermined pose shown in FIG. 8. In this pose the subject may be standing with a neutral spine, and the subject's arms may be abducted at the shoulder. The upper arms may be extended laterally in the coronal plane. The elbows may be flexed with the hands resting on the head. For example, the pre-determined pose described with reference to FIG. 7 further comprises the subject's hands/fingers touching each side of the head, for example approximately around the ear.

The data processor 706 then identifies, based on the digital image of the subject in the predetermined pose, at least one morphological parameter of the subject's body, such as a parameter of the breast, and provides garment fit data based on the at least one morphological parameter. Garment fit data is provided based on a stored association between morphological parameters of a human breast and garment fit data. Example garment fit data may comprise garment size information or a manufacturing parameter, for example seam lengths, relating to a manufacturable garment. The data processor 706 is further configured to provide a control signal for controlling a garment provision system 708 for the provision of a manufactured garment according to the garment fit data.

The garment provision system 708 may comprise an automated manufacturing means that manufactures a garment based on the garment fit data in response to the control signal. Alternatively, the garment provision system 708 may comprise a plurality of pre-manufactured garments and optionally one or more robots, which may form part of an automated or semi-automated system. In response to the control signal, the garment provision system 708 may be configured to select at least one of the pre-manufactured garments to fit the subject based on the garment fit data. The selecting of the at least one pre-manufactured garment may be achieved using an automated or semi-automated selection system, which may comprise a robot for example a robotic picking system. The garment provision system 708 may also comprise an automated or semi-automated distribution system configured to provide the manufactured garment to the human subject.

In some examples, the apparatus 700 further comprises an image capture device, for example a camera, operable to capture a first digital image of the subject, wherein the processor 706 is configured to determine based on the digital image, whether the subject is in the predetermined pose, and to cause the capture of a further image in the event that the subject is not in the predetermined pose in the first digital image.

In some examples, the method 5000 further comprises analysing the digital image to identify, in the digital image, a location of at least one anatomical marker, for example a location of the shoulder joints and/or a location of the umbilicus, and determining at least one of morphological parameter of the subject's breast based on said locations and the digital image. For example, a bandline measurement may be determined based on the locations of at least one anatomical marker, for example the location of the shoulder joints and/or a location of the umbilicus. This is discussed in more detail in relation to FIGS. 1 and 3D.

In some examples, the garment fit data may comprise at least one of garment size, and a manufacturing parameter of a garment. An example manufacturing parameter of a garment may include seam length of a garment.

In some examples, the digital image of the subject in a pre-determined pose further comprises a reference object positioned in a pre-determined location relative to the subject's body, and wherein the data processor is further configured to determine size information of the subject based on an apparent size of the reference object in the digital image, for example as described in more detail below in relation to FIGS. 9A to 10. In some examples, determining the at least one morphological parameter is based on the size information of the subject.

FIG. 1 shows an example method (1000) for obtaining an image (5020) and determining at least one morphological parameter of a human breast (5040), for example for use with the example apparatus of FIG. 13 and the method of FIG. 14. Firstly, the processor 700 obtains at least one image of the subject (5020). The image may be obtained from the image store 702. In this example, the at least one image comprises a plurality of two-dimensional images. The example method (1000) is described in more detail above in relation to the respective aspect/embodiment shown in FIGS. 1 and FIGS. 3A to 10I described above but the same approach can be used with the aspect/embodiment of FIGS. 13 and 14.

A control signal may then be provided to a garment provision system for the provision of a manufactured garment according to the garment fit data.

Garment fit data may then be determined based on a stored association, for example stored in the garment fit data store 704, between known morphological parameters, for example bandline length, and garment fit data. The fit of a real garment is determined using the garment fit data by the similarity of the morphological parameter measurements to real garment measurements associated with the morphological parameters, wherein more similar measurements correspond to a better fit. A control signal may then be provided to a garment provision system for the provision of a manufactured garment according to the garment fit data.

First a set of images of a human subject (or user) is obtained (3000), for example from the image store 702. The images show the subject standing, e.g. with their spine in a neutral position, and with his or her arms abducted at the shoulders. The arms may be flexed so that the subject's hands can be placed on his or her head. The images include a set of views, each taken from a different view point of the subject—for example from a different azimuthal angle so that the images show a front view and a set of other views, such as a rear view and/or a right profile and/or a left profile, and/or a number of intermediate or oblique views angularly spaced between the front and rear.

The processor 706 obtains camera information, which may be provided in metadata accompanying the images, for example as part of the image file format e.g. in a file header which may comprise the angular field of view of the camera. The processor 706 is configured to use such camera information to determine the focal length of the camera. The distance of the camera from the projection plane (the object plane) is then calculated, based on the focal length of the camera. This may be used to determine size information of the subject, e.g. for use in converting image/pixel measurements into real world measurements. However, the skilled person will appreciate in the context of the present disclosure that other methods to extract size information may be used, for example including the use of a reference object, for example as discussed in more detail in relation to FIGS. 9 to 10, or a combination of the use of a reference object and extracting camera information.

The processor 706 analyses the images to identify an approximate location of the shoulder joints in each image of the set of images (3020). The processor 706 may be configured to do this by applying a deep learning algorithm such as a Real-Time and Accurate Full-Body Multi-Person Pose Estimation & Tracking System, for example AlphaPose (RMPE: Regional Multi-person Pose Estimation; Fang, Xie, Tai, Lu; ICCV; 2017; https://www.mvig.org/research/alphapose.html). Other feature identification methods may be used, for example contour, curvature, or template-matching techniques.

The processor then analyses the images to identify centre of rotation of the subject's body, this may be done by identifying a pose registration axis wherein the pose registration axis passes through the mid-point between the shoulder joints (3060). It is therefore assumed that rotation of the subject is a rotation about the pose registration axis, and that the pose registration axis lies on the projection plane. Other ways of calculating the pose registration axis may also be used. For example, by the processor identifying the outline of the body in each image, and then for each row of pixels (horizontal) in the image identifying the average position of the subject in that row, and then finding the straight line which best fits these average positions in each row. This may provide an approximation to the pose registration axis in each of the images. The processor 706 then identifies a front view image from the set of images, or at least the image which is closest to a front view of the subject. This may be done (3060) by the processor selecting the image in which the distance between the locations of the shoulder joints in that image is greatest, for example as shown in more detail with reference to FIG. 4A. It may also be done by selecting the image in which the line between the shoulder joints is closest to horizontal and/or closest to perpendicular to the pose registration axis.

The processor 706 then defines a circle in 3D space (3080)—e.g. by calculating a set of 3D coordinates. This circle corresponds to the rotation of the shoulder joint locations identified in the front view image about the midpoint calculated in the preceding step (3040), for example as shown in more detail with reference to FIG. 4B. This rotation may be a rotation in a horizontal plane (e.g. parallel to the rows of pixels or perpendicular to the pose registration axis). The processor 706 then calculates the projection of this circle onto the 2D-plane parallel with the front view image for each of a set of angular positions distributed about this circle (3100)—for example these angular positions may be regularly spaced such as at 1° or 2° increments. The processor thus generates an association between a set of angles, and a corresponding set of projected coordinates.

These projected positions correspond to the expected position of the shoulder joints when the subject is standing in the relevant angular position.

Then for each image in the set of images of the subject, the processor 706 uses the shoulder joint locations identified by the deep learning and finds the projected positions which match these most closely, thereby to assign an angular position to each image of the subject (3120). In the event that one of the shoulder joint locations is missing from an image, the processor 706 is configured to provide an estimate of the missing shoulder joint location. It does this based on the angular position information identified in the preceding step of the method. In particular, the processor determines a predicted location of the missing shoulder joint based on its location in at least one other image in the set of images (such as the image(s) at the nearest adjacent angular locations). This may be done by the processor interpolating between known shoulder joint locations of the other images to identify its likely position in the image from which it is missing. This interpolation may be done by fitting a curved path, such as an ellipse to the known shoulder joint locations and then selecting a location on this curved path using the angular position of the image from which the shoulder is missing. The curved path corresponds to the circle of rotation viewed with respect to the position of the camera. The location of a missing shoulder joint can thus be estimated based on these angular positions and the other images of the set.

The processor 706 may also use this assignment of angular position of each of the images to improve the estimate of the shoulder joint locations (3140) in the manner described below with reference to FIG. 3B. This method of stabilising shoulder joint locations is repeated iteratively until the processor determines that a stability threshold has been reached (3160), for example when the joint location doesn't change by more than a threshold amount between iterations, at which point the shoulder joint locations can be provided for use in further methods of the present disclosure and/or output (3180) to a resource such as a memory and/or for use in the co-registration of the 2D images of the subject with a 3D model of the standard human anatomy-such as by deforming that 3D model onto the shoulder joint locations.

The method of stabilising the shoulder joint locations mentioned above with reference to FIG. 3A will now be explained by reference to FIG. 3B.

The processor 706 selects the image Fn in which the shoulder joint locations are to be stabilised, and it also selects the “preceding” frame Fn−1 (3200). It will be appreciated in the context of the present disclosure that this need not be the temporally preceding image, but may instead simply be an angularly adjacent image from the set of images—e.g. the image in which the view of the subject has the closest angular position (as defined above) to the image Fn.

The processor 706 then applies a feature extraction analysis to both images Fn−1 and Fn. This feature extraction analysis may be an affine invariant contour based feature extraction (3220). For example, wherein the use of the contour (i.e. the shape of the shoulders) is able to detect the shoulder joints. This approach is invariant to transformations such as rotation, affine transforms, and scaling. Other methods of feature extraction analysis may also be used. For example, a template based approach or a marker based approach where any marker on the subject's shoulder, such as a marker on the subject's garment (e.g. shoulder straps), or image annotation could be used to identify the shoulder.

The feature extraction analysis thus provides, for each image Fn−1 and Fn an identifiable set of features and a corresponding set of locations for each feature in each of the two images. The processor then determines an association, such as a spatial transform, between the image Fn and the image Fn−1 (3240). The association describes how the set of locations for each feature are related and can be transformed from the corresponding set of locations in the image Fn−1 to the image Fn. This transformation is based on the angular positions of the images to locate the features in 3D space, for example based on the projected circle corresponding to the rotation of the shoulder joint locations. In some examples, the transformation is also based on scaling information and camera viewpoint corrections. The transformation may also correct for oscillation of the subject in the x-direction, parallel to the plane of the camera. Oscillation in the x-direction is determined by tracking the position of the mid-point of rotation.

The processor 706 then determines a predicted shoulder joint location in the image Fn based on this association and the shoulder joint locations in the other image Fn−1 (3260).

The processor 706 then combines the predicted shoulder joint location (predicted from 25 Fn−1) with the current estimate of shoulder joint location for the image Fn (determined by feature analysis) to provide an updated estimate of the shoulder joint location in Fn (3280). This update may be performed using a weighted combination, for example wherein weighting is based on the probability of the shoulder joint location.

The updated shoulder joint location is then output from this process (3300), e.g. output to a resource such as a memory for use as described above with reference to FIG. 3A.

At this stage, the processor 706 has determined, based on the set of images, a set of 5 estimates of the shoulder joint locations with respect to a centre of rotation of the subject. The processor 706 can combine these estimates to provide a single properly stabilised estimate of the two shoulder joint locations and/or also an estimate of the pose registration axis, wherein the pose registration axis is determined to pass through the mid-point between the shoulder joints.

FIG. 3C provides a schematic illustration of a method of identifying the location of the subject's umbilicus. The umbilicus is first identified in the front view image (3320), which may have been selected as described above with reference to FIG. 3A (3040). The processor 706 then analyses the images to identify an approximate location of the umbilicus in the remaining images. The processor 706 may be configured to do this by applying a deep learning algorithm such as a neural network or a residual network, for example a R-CNN, for example Faster R-CNN with ResNet, as described at He, K., Zhang, X., Ren, S. and Sun, J., 2015. Deep Residual Learning for Image Recognition. [online] arXiv.org. Available at: <https://arxiv.org/abs/1512.03385> [Accessed 2 Jul. 2021]; and Ren, S., He, K., Girshick, R. and Sun, J., 2016. Faster R-CNN: Towards Real-Time Object Detection with Region Proposal Networks. [online] arXiv.org. Available at: <https://arxiv.org/abs/1506.01497> [Accessed 2 Jul. 2021]. Umbilicus detection may be based on texture analysis, for example based on texture lines. Other methods of umbilicus detection may also be used, for example, clustering techniques.

The processor 706 then defines a second circle in 3D space—e.g. by calculating a set of 25 3D coordinates. This circle corresponds to the rotation of the umbilicus about the pose registration axis based on the location of the umbilicus identified in the set of images.

Based on the angular position for each image calculated above in relation to FIG. 3A, the processor 706 thus generates an association between a set of angles, and a corresponding set of projected coordinates. These projected positions corresponding to the expected position of the umbilicus when the subject is standing in the relevant angular position. For the angularly adjacent images, the processor 706 estimates the location of the umbilicus based on its position in the front view image and the angle between that image and the front view image. This may be done by assuming that the umbilicus moves through an elliptical path, corresponding to the second circular path viewed with respect to the position of the camera, as the subject rotates. The position of the umbilicus is tracked using the elliptical path to estimate the position/height of the umbilicus in the side view image, as determined by the radius of rotation of the umbilicus, for example as shown in more detail with reference to FIG. 4C.

The estimated umbilicus positions may then be stabilised (3360) by following a method similar to that described above with reference to FIG. 3B for the shoulder joints. In particular, the processor 706 analyses the image Fn in which the location of the umbilicus is to be stabilised to identify features, such as texture based features in that image and corresponding features in another image in which the location of the umbilicus has already been estimated. Other feature extraction analysis methods may be used to identify the umbilicus, for example clustering, or a combination of texture analysis and clustering. The image in which the location of the umbilicus has already been estimated is then also analysed to identify the same (or corresponding) features. By determining the mapping between the features of image Fn and the image Fn−1 an association between the two images, such as a spatial transform, is determined by the processor. The processor 706 then applies this association to the image in which the location of the umbilicus is known to predict the location of the umbilicus in the image to be stabilised.

The predicted location and any prior estimate of the location can then be combined to estimate the umbilicus location for that image (3400).

The location of the umbilicus, and the angular data describing the images (see above) is used to determine the location in 3D space of certain landmarks of the human skeleton such as the junction between the 3rd and 4th vertebrae.

The location of the shoulder joints may then be used together with the locations of the umbilicus to identify to provide a mapping between the model of standard human anatomy and the images of the subject, and/or provide the position of the subject's bandline.

Any feature of any one of the examples disclosed herein may be combined with any selected features of any of the other examples described herein. For example, features of methods may be implemented in suitably configured hardware, and the configuration of the specific hardware described herein may be employed in methods implemented using other hardware.

It will be appreciated from the discussion above that the embodiments shown in the Figures are merely exemplary, and include features which may be generalised, removed or replaced as described herein and as set out in the claims. With reference to the drawings in general, it will be appreciated that schematic functional block diagrams are used to indicate functionality of systems and apparatus described herein. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some embodiments the function of one or more elements shown in the drawings may be integrated into a single functional unit.

In some examples the functionality of the computer processor described herein may be provided by a general purpose processor, which may be configured to perform a method according to any one of those described herein. In some examples the controller may comprise digital logic, such as field programmable gate arrays, FPGA, application specific integrated circuits, ASIC, a digital signal processor, DSP, or by any other appropriate hardware. In some examples, one or more memory elements can store data and/or program instructions used to implement the operations described herein. Embodiments of the disclosure provide tangible, non-transitory storage media comprising program instructions operable to program a processor to perform any one or more of the methods described and/or claimed herein and/or to provide data processing apparatus as described and/or claimed herein. The controller may comprise an analogue control circuit which provides at least a part of this control functionality. An embodiment provides an analogue control circuit configured to perform any one or more of the methods described herein.

The above embodiments are to be understood as illustrative examples. Further embodiments are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

Machine learning is the field of study where a computer or computers learn to perform classes of tasks using the feedback generated from the experience or data gathered that the machine learning process acquires during computer performance of those tasks.

Typically, machine learning can be broadly classed as using either supervised or unsupervised approaches, although there are particular approaches such as reinforcement learning and semi-supervised learning which have special rules, techniques and/or approaches.

Supervised machine learning is concerned with a computer learning one or more rules or functions to map between example inputs and desired outputs as predetermined by an operator or programmer, usually where a data set containing the inputs is labelled.

Unsupervised learning is concerned with determining a structure for input data, for example when performing pattern recognition, and typically uses unlabelled data sets.

Reinforcement learning is concerned with enabling a computer or computers to interact with a dynamic environment, for example when playing a game or driving a vehicle.

Various hybrids of these categories are possible, such as “semi-supervised” machine learning where a training data set has only been partially labelled. For unsupervised machine learning, there is a range of possible applications such as, for example, the application of computer vision techniques to image processing or video enhancement.

Unsupervised machine learning is typically applied to solve problems where an unknown data structure might be present in the data. As the data is unlabelled, the machine learning process is required to operate to identify implicit relationships between the data for example by deriving a clustering metric based on internally derived information. For example, an unsupervised learning technique can be used to reduce the dimensionality of a data set and attempt to identify and model relationships between clusters in the data set, and can for example generate measures of cluster membership or identify hubs or nodes in or between clusters (for example using a technique referred to as weighted correlation network analysis, which can be applied to high-dimensional data sets, or using k-means clustering to cluster data by a measure of the Euclidean distance between each datum).

Semi-supervised learning is typically applied to solve problems where there is a partially labelled data set, for example where only a subset of the data is labelled. Semi-supervised machine learning makes use of externally provided labels and objective functions as well as any implicit data relationships. When initially configuring a machine learning system, particularly when using a supervised machine learning approach, the machine learning algorithm can be provided with some training data or a set of training examples, in which each example is typically a pair of an input signal/vector and a desired output value, label (or classification) or signal. The machine learning algorithm analyses the training data and produces a generalised function that can be used with unseen data sets to produce desired output values or signals for the unseen input vectors/signals. The user needs to decide what type of data is to be used as the training data, and to prepare a representative real-world set of data. The user must however take care to ensure that the training data contains enough information to accurately predict desired output values without providing too many features (which can result in too many dimensions being considered by the machine learning process during training and could also mean that the machine learning process does not converge to good solutions for all or specific examples). The user must also determine the desired structure of the learned or generalised function, for example whether to use support vector machines or decision trees.

The use of unsupervised or semi-supervised machine learning approaches are sometimes used when labelled data is not readily available, or where the system generates new labelled data from unknown data given some initial seed labels.

Machine learning may be performed through the use of one or more of: a non-linear hierarchical algorithm; neural network; convolutional neural network; recurrent neural network; long short-term memory network; multi-dimensional convolutional network; a memory network; fully convolutional network or a gated recurrent network allows a flexible approach when generating the predicted block of visual data. The use of an algorithm with a memory unit such as a long short-term memory network (LSTM), a memory network or a gated recurrent network can keep the state of the predicted blocks from motion compensation processes performed on the same original input frame. The use of these networks can improve computational efficiency and also improve temporal consistency in the motion compensation process across a number of frames, as the algorithm maintains some sort of state or memory of the changes in motion. This can additionally result in a reduction of error rates.

Developing a machine learning system typically consists of two stages: (1) training and (2) production.

During the training the parameters of the machine learning model are iteratively changed to optimise a particular learning objective, known as the objective function or the loss.

Once the model is trained, it can be used in production, where the model takes in an input and produces an output using the trained parameters.

During the training stage of neural networks, verified inputs are provided, and hence it is possible to compare the neural network's calculated output to then the correct the network is need be. An error term or loss function for each node in neural network can be established, and the weights adjusted, so that future outputs are closer to an expected result. Backpropagation techniques can also be used in the training schedule for the or each neural network.

The model can be trained using backpropagation and forward pass through the network. The loss function is an objective that can be minimised, it is a measurement between the target value and the model's output.

The cross-entropy loss may be used. The cross-entropy loss is defined as

$${L}_{CE} = - {\sum }_{c = 1}^{C} y * log ( s )$$

where C is the number of classes, y∈{0,1} is the binary indicator for class c, and s is the score for class c.

In the multitask learning setting, the loss will consist of multiple parts. A loss term for each task.

$$L ( x ) = {λ}_{1} {L}_{1} + {λ}_{2} {L}_{2}$$

where L₁, L₂ are the loss terms for two different tasks and λ₁, λ₂ are weighting terms.

For the avoidance of doubt, the reader should note that the bandline length, the bandline location, the breast-garment association and the garment size are properties of a garment and not of a subject's breast.

Any system feature as described herein may also be provided as a method feature, and vice versa. As used herein, means plus function features may be expressed alternatively in terms of their corresponding structure.

Any feature in one aspect may be applied to other aspects, in any appropriate combination. In particular, method aspects may be applied to system aspects, and vice versa. Furthermore, any, some and/or all features in one aspect can be applied to any, some and/or all features in any other aspect, in any appropriate combination.

It should also be appreciated that particular combinations of the various features described and defined in any aspects can be implemented and/or supplied and/or used independently.

What is claimed is:

1. A computer-implemented method of determining morphology of a human breast, the method comprising:
obtaining at least one image of a human subject;
extracting features of at least a portion of the subject's body from the at least one image, wherein the features correspond to a model of standard human anatomy;
generating a three-dimensional model of the subject's body based on the extracted features and the model of standard human anatomy; and
determining a morphological parameter of the subject's breast from the three-dimensional model of the subject's body.

2. The computer-implemented method of claim 1 wherein generating the three-dimensional model of the subject further comprises deforming the model of standard human anatomy based on the extracted features.

3. The computer-implemented method of claim 2 wherein deforming the model of the standard human anatomy comprises mapping anatomical markers of the model of standard human anatomy onto the extracted features, wherein the extracted features correspond to said anatomical markers for the subject's body.

4. The computer-implemented method of claim 1 wherein the extracted features and/or the anatomical markers comprise the umbilicus and at least one of the shoulder joints.

5. The computer-implemented method of claim 1 wherein extracting features of at least a portion of the subject's body further comprises extracting edge information of at least a portion of the subject's body from the image.

6. The computer-implemented method of claim 5 wherein extracting features of at least a portion of the subject's body further comprises identifying and measuring points of inflection based on the edge information.

7. The computer-implemented method of claim 5 wherein the points of inflection are used to identify anatomical regions of interest, optionally wherein said anatomical regions of interest comprise a breast root.

8. The computer-implemented method of claim 1 wherein generating the three-dimensional model of the subject further comprises scaling the three-dimensional model of the subject based on size information obtained from the image.

9. The computer-implemented method of claim 8 wherein at least one of the images comprise a reference object, the method comprising determining size information of the three dimensional model of the subject based on an apparent size of the reference object in the at least one image.

10. The computer-implemented method of claim 9 wherein the reference object is positioned on the same plane as at least a portion of the subject's body in the image.

11. (canceled)

12. (canceled)

13. The computer-implemented method of claim 1 wherein any or any combination of: (a) extracting features of at least a portion of the subject's body; and (b) generating the three-dimensional model of the subject's body; comprise using one or more machine-learned models.

14. The computer-implemented method of claim 1 wherein the three-dimensional model comprises any or any combination of: a skeleton model; and a three-dimensional volume model.

15. (canceled)

16. The computer-implemented method of claim 1 further comprising determining garment parameters wherein determining garment parameters comprises:
adjusting a virtual garment to fit the three-dimensional model; and
determining at least one of:
(a) a morphological parameter of the breast based on the adjusted virtual garment; and
(b) a parameter of a real garment based on the adjusted virtual garment.

17. The computer-implemented method of claim 16 wherein the virtual garment comprises a support element configured to support at least a portion of the subject's breast and wherein adjusting the virtual garment to fit the three-dimensional model comprises:
deforming a breast part of three-dimensional model of the subject to fit the support element, wherein the deforming is constrained to preserve volume of the breast part of the three-dimensional model.

18. The computer-implemented method of claim 16 wherein the method comprises: identifying a desired morphology of at least one of the subject's breasts; adjusting a virtual prosthesis so that, when the virtual prosthesis is positioned on the three-dimensional model to augment a virtual breast of the model, the augmented virtual breast has the desired morphology, optionally wherein the virtual garment (a) comprises the virtual prosthesis or (b) consists solely of the virtual prosthesis.

19. The computer implemented method of claim 18 wherein the desired morphology comprises a desired shape, and the adjusting the virtual prosthesis comprises deforming the virtual prosthesis while constraining a total volume of the virtual prosthesis.

20. The computer-implemented method of claim 18 wherein the method comprises:
identifying a first morphological parameter of a first one of the subject's breasts, such as volume, wherein the virtual prosthesis corresponds to the second one of the subject's breasts; and
deforming the virtual prosthesis under a constraint that the first morphological parameter of the virtual prosthesis matches the first morphological parameter of the first one of the subject's breasts; and
identifying a second morphological parameter of the adjusted virtual prosthesis.

21. The computer-implemented method of claim 13, the method comprising determining at least one of
(i) a garment size and
(ii) a manufacturing parameter
of at least one of real prosthesis and a real garment based on the determined morphological parameters.

22. The computer-implemented method of claim 16 further comprising determining any or any combination of: bandline length; bandline location; breast-garment association; and garment size.

23. (canceled)

24. The computer-implemented method of claim 1 wherein the image of the subject comprises the subject in a pre-determined pose, wherein the predetermined pose comprises a neutral spine and abduction of the arms at the shoulder, for example with the upper arms extended laterally in the coronal plane.

25-55. (canceled)
